(19) United States
(12) Patent Application Publication
(10) Pub. No.: US 2025/0156966 A1
(43) Pub. Date: May 15, 2025

(54) WELL STATUS DETERMINATION

(71) Applicant: Halliburton Energy Services, Inc., Houston, TX (US)

(72) Inventors: Neil Alan OSTERMANN, Houston, TX (US); Beau D. BECK, Gregory, SD (US); Joel Thomas WALDEN, Tomball, TX (US); William J. STARK, Thornton, CO (US)

(73) Assignee: Halliburton Energy Services, Inc., Houston, TX (US)

(21) Appl. No.: 18/510,391

(22) Filed: Nov. 15, 2023

(51) Int. Cl. E21B 43/26; E21B 23/14

(52) U.S. Cl. CPC G06Q 50/02; E21B 43/00

(57) ABSTRACT

Described herein are systems and techniques for determining a status of a wellhead of a well. An example computing system may be configured to determine a first well is closed based on wellhead status data; determine a wireline crane is not positioned over the first well based on wireline crane positioning data; determine a fracture crane is positioned over the first well based on fracture crane positioning data; determine a current status of the first well based on a portion of job data associated with the first well, and fracturing equipment data; and initiate one or more wellhead operations based on the current status of the first well.

### BACKGROUND

### 1. Technical Field

The present disclosure generally relates to well control and status technologies and, more specifically, integration of total job configuration information, including stage status, and the position of relevant equipment, such as a wireline crane and frac crane to determine a status of operations associated with a wireline crane and/or a status of operations associated with a frac crane.

### 2. Introduction

In some examples, a drill site may include multiple wells. Additionally, a set of plug and perforating operations may be performed on each of the multiple wells. The set of plug and perforating operations may include a set of wireline stages/operations and a set of fracture stages/operations, such as fracturing stages/operations associated with hydraulic fracturing. Moreover, the set of plug and perforating operations may include alternating the wireline stages/operations and the fracture stages/operations. For instance, a wireline stage of the set of wireline stages may not be initiated until completion of a previously initiated fracture stage of the set of fracture stages is completed. Alternatively, in another instance, a fracture stage of the set of fracture stages may not be initiated until completion of a previously initiated wireline stage.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example drill site environment according to some examples of the present disclosure;

FIG. 2 illustrates an example computing environment, according to some examples of the present disclosure;

FIG. 3 illustrates a flow chart of an exemplary process for determining a status of a wellhead of a well that is closed, and a frac crane is positioned over the well, according to some examples of the present disclosure;

FIG. 4 illustrates a flow chart of an exemplary process for determining a status of a wellhead of a well that is closed, and a wireline crane is positioned over the well, according to some examples of the present disclosure;

FIG. 5 illustrates a flow chart of an exemplary process for determining a status of a wellhead of a well that is open, and a frac crane is positioned over the well, according to some examples of the present disclosure;

FIG. 6 illustrates a flow chart of an exemplary process for determining a status of a wellhead of a well that is open, and a wireline crane is positioned over the well, according to some examples of the present disclosure;

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

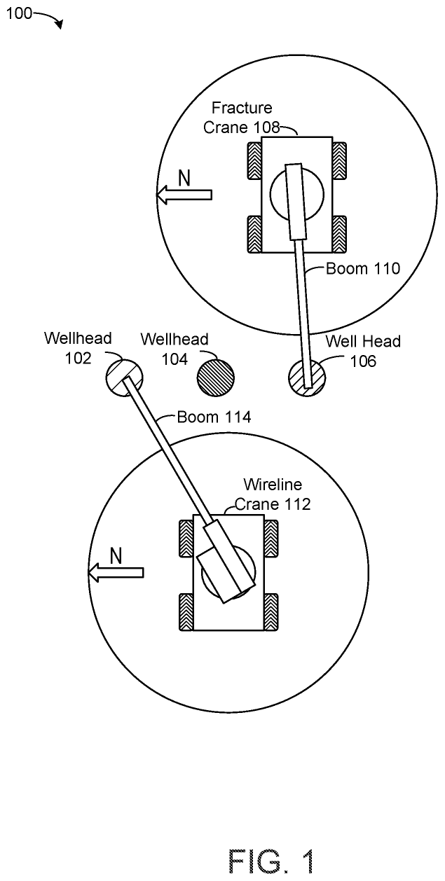

In some examples, a decentralized computing environment may include multiple computing systems that monitor and manage fracturing equipment and wireline equipment that are utilized to perform fracturing stages and wireline stages of a set of plug and perforating operations. In such examples, the set of plug and perforating operations may be performed on each of multiple wells of a drill site. As illustrated in FIG. 1, an example drill site environment 100 may include multiple wells, such as a well of wellhead 102, well of wellhead 104 and well of wellhead 106. Additionally, a set of plug and perforating operations may be performed on each of the multiple wells. In such examples, the data gathered by each of these multiple computing systems are crucial for safety reasons to avoid catastrophic events. For instance, for a well, a fracture stage of a set of plug and perforating operations may be in the process of being completed. In such an instance, if operators shut in or close the well during the completion of a fracture stage, high pressure may build up within the well and an explosion may result. In another instance, for a well, a wireline stage of a set of plug and perforating operations may be in the process of being completed. In such an instance, if operators shut in or close the well during the completion of a wireline stage, a cable and attached wireline tools (e.g., a perforating device) may be lost in the well. In yet another instance, a well may have the wrong type of stage (e.g., wireline or fracturing) performed on the well due to misidentification of the well. However, it may be harder and more difficult to determine the likelihood of an occurrence of these catastrophic events due to the decentralized nature of the computing environment.

Aspects of the disclosed technology provide solutions for centralizing such computing environments to make it easier and more efficient to determine the likelihood of an occurrence of the aforementioned catastrophic events. Additionally, the solutions may include adding additional sensors to wireline cranes (e.g., wireline crane 112 of FIG. 1), fracture cranes (e.g., fracture crane 108) and a wellhead of each of the multiple wells included in the drill site. The sensor data of the additional sensors may provide additional information/data that may make determinations related to the aforementioned catastrophic events more accurate and comprehensive. Examples of the additional sensors include, a location type sensor (e.g., GPS sensor or sensor system (e.g., a centimeter precision GPS system) and a magnetometer) and a valve sensor.

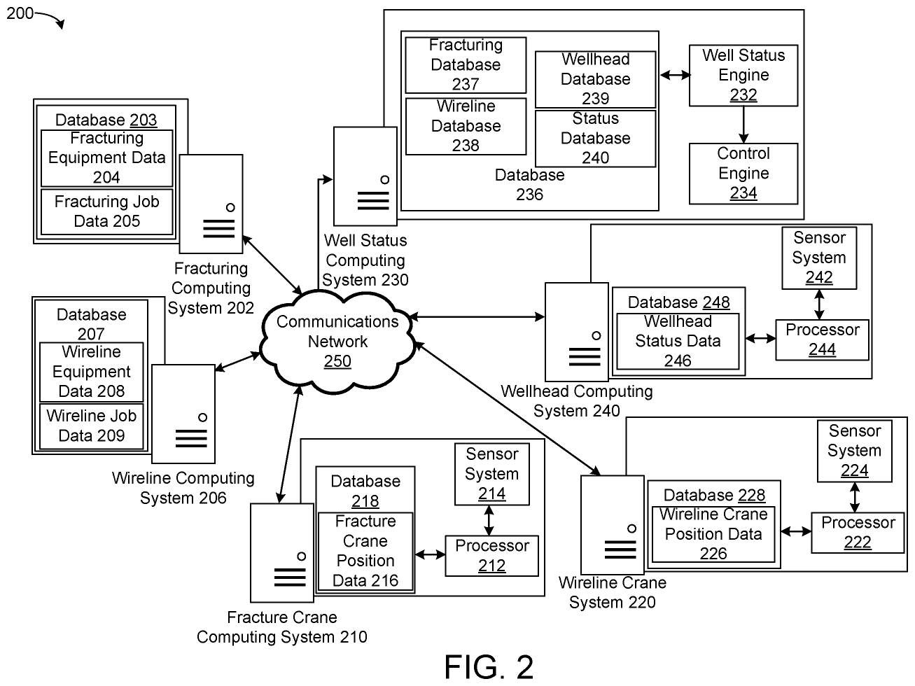

Referring to FIG. 2, example computing environment 200 may include one or more computing systems, such as fracturing computing system 202, wireline computing system 206, fracture crane computing system 210, wireline crane computing system 220, well status computing system 230, and wellhead computing system 240. The one or more computing systems may be interconnected through any appropriate combination of communications networks, such as communications network 250.

Examples of communications network 250 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. In some instances, the devices and systems operating within computing environment 200 may perform operations that establish and maintain one or more secure channels of communication across communications network 250, such as, but not limited to, a transport layer security (TSL) channel, a secure socket layer (SSL) channel, or any other suitable secure communication channel.

As described herein, well status computing system 230 may perform any of the example processes described herein, to among other things, obtain, for each of one or more wells of a drill site I (e.g., well of wellhead 102, well of wellhead 104, or well of wellhead 106, as illustrated in FIG. 1), fracturing equipment data 204, fracturing job data 205, wireline equipment data 208, wireline job data 209, fracture crane position data 216, wireline crane position data 226, and/or wellhead status data 246. As described herein fracturing equipment data 204 may include data or information associated with one or more fracturing equipment managed, controlled and/or monitored by fracturing computing system 202, while wireline equipment data 208 may include data or information associated with one or more wireline equipment managed, controlled and/or monitored by wireline computing system 206. Additionally, fracturing job data 205 may include data indicating status of each of one or more fracturing operations or fracture stages of a set of plug-and-perf operations, while wireline job data 209 may include data indicating status of each of one or more wireline operations or fracture stages of a set of plug-and-perf operations. Moreover, fracture crane position data 216 may include data identifying a position/location and/or orientation of a boom of a fracture crane (e.g., boom 110 of fracture crane 108 as illustrated in FIG. 1), while wireline crane position data 226 may include data identifying a position/location and/or orientation of a boom of a wireline crane (e.g., boom 114 of wireline crane 112 as illustrated in FIG. 1). Further, wellhead status data 246 may include data identifying the status of a wellhead of a well (e.g., wellhead 104 of a well of in FIG. 1), such as whether the wellhead is open or closed.

Based on the obtained data (e.g., fracturing equipment data 204, fracturing job data 205, wireline equipment data 208, wireline job data 209, fracture crane position data 216, wireline crane position data 226, and/or wellhead status data 246), well status computing system 230 may perform any of the example processes described herein, to among other things, determine a status of each of the well based on the corresponding obtained data. As described herein the status may indicate whether the corresponding well is in use, the type of use (e.g., fracturing operations/stages or wireline operations/stages) and in some instances whether the well is ready for the next stage of fracturing or wireline stages/operations. Further, well status computing system 230 may perform any of the example processes described herein, to among other things, initiate and perform one or more wellhead operations, that includes but is not limited to, generating, and presenting a notification associated with the determined status of the well, and opening or closing the corresponding wellhead.

Each of the computing systems, such as fracturing computing system 202, wireline computing system 206, fracture crane computing system 210, wireline crane computing system 220, wellhead computing system 240 and well status computing system 230, may represent a computing system that includes one or more servers and tangible, non-transitory memory devices storing executable code and application modules. The one or more servers may each include one or more processors or processor-based computing devices, which may be configured to execute portions of the stored code or application modules to perform operations consistent with the disclosed embodiments. Further, in some examples, each of the computing systems, such as fracturing computing system 202, wireline computing system 206, fracture crane computing system 210, wireline crane computing system 220, wellhead computing system 240 and well status computing system 230, may include a communications unit or interface coupled to the one or more processors for accommodating wired or wireless communication across communications network 250 with any of the computing systems or any additional network-connected systems or devices described herein.

As described herein, fracturing computing system 202 may perform any of the example processes described herein, to among other things, control or manage (automatically or manually) one or more fracturing equipment. Additionally, fracturing computing system 202 may utilize the one or more fracture equipment to perform the set of fracture stages on one or more wells, such as well of wellhead 102, well of wellhead 104 and/or well of wellhead 106 as illustrated in FIG. 1. Examples of the one or more fracture equipment may include one or more fracture pumps (e.g., reciprocating positive displacement pumps), fracture blenders (e.g., machinery that performs operations associated with well acidizing and proppant blending), fracture sand equipment (e.g., sand storage and delivery systems for continuous delivery of proppant to one or more fracture blenders), and chemical delivery units (e.g., units, devices or systems that delivery/provide chemical additives that for the fracturing operations/stages). For instance, fracturing computing system 202 may control the one or more fracture pumps to pump a mixture of sand and water down the well and through small perforations created by a wireline tool (e.g., a perforation device). In such an instance, fracturing computing system 202 may control the pump rate of each of the one or more pumps.

In some instances, fracturing computing system 202 may control or manage one or more fracture equipment to implement a set of fracture stages for a set of plug and perf operations for a well, such as well of wellhead 102, well of wellhead 104 or well of wellhead 106 as illustrated in FIG. 1. In such instances, fracturing computing system 202 may generate fracturing job data 205 that identifies and characterizes, for each well, an identifier associated with the well (e.g., an alphanumeric identifier), a fracture stage the one or more fracturing equipment are currently completing or has initiated and/or a fracture stage the one or more fracturing equipment have subsequently completed. In some instances, fracturing computing system 202 may generate fracturing job data 205, automatically. Additionally, or alternatively, fracturing computing system 202 may generate fracturing job data 205 based on one or more user inputs provided by one or more operators of fracturing computing system 202 and/or operators of each of the one or more fracture equipment.

Additionally, fracturing computing system 202 may perform any of the example processes described herein, to among other things, monitor the conditions of each of the one or more fracture equipment. Each of the fracture equipment may include one or more sensors that generate sensor data indicating the conditions of corresponding fracture equipment. Moreover, fracturing computing system 202 may determine the conditions of each of the one or more fracture equipment based on associated sensor data. Examples of the conditions include a flow rate or pump rate (e.g., barrels per minute or gallons per minute) of a pump and a pressure (e.g., psi) of the pump. Further, fracturing computing system 202 may generate fracturing equipment data 204 based on the determined conditions of each of the one or more fracture equipment. In some instances, fracturing equipment data 204 may, for each of the one or more fracture equipment, identify the corresponding fracture equipment (e.g., an alphanumeric identifier), identify the type of fracture equipment (e.g., pump), and one or more current conditions of the corresponding fracture equipment (e.g., a current pump rate and/or pressure).

Further, fracturing computing system 202 may include one or more tangible, non-transitory memories, such as database 203. In some instances, fracturing computing system 202 may perform operations that store, within the one or more tangible non-transitory memories of fracturing computing system 202, such as database 203, fracturing job data 205. In other instances, fracturing computing system 202 may perform operations that store, within the one or more tangible non-transitory memories of fracturing computing system 202, such as database 203, fracturing equipment data 204.

As described herein, wireline computing system 206 may perform any of the example processes described herein, to, among other things, control or manage (automatically or manually) one or more wireline equipment. The one or more wireline equipment, such as one or more pump down pumps, a winch and a wireline tool (e.g., a plug and perforation device), may be utilized to perform a set of wireline stages for one or more wells, such as well of wellhead 102, well of wellhead 104 and/or well of wellhead 106 as illustrated in FIG. 1. Examples of one or more wireline equipment may include one or more pump down pumps, a winch and a wireline tool (e.g., a plug and perforation device), pressure control equipment (e.g., equipment that is used to contain the wireline tool and may be configured to equalize the pressure above and below the wellhead prior to opening the wellhead of the well), and cameras. For instance, wireline computing system 206 may control a pump down pump to pump a fluid down a well to position the wireline tool to a desired depth. In such an instance, wireline computing system 206 may control the pump rate of the pump down pump.

In some instances, wireline computing system 206 may control or manage one more wireline equipment for a set of wireline stages of a set of plug and perforating operations for a well, such as well of wellhead 102, well of wellhead 104 or well of wellhead 106 as illustrated in FIG. 1. In such instances, wireline computing system 206 may generate wireline job data 209 that identifies and characterizes, for each well, an identifier associated with the well (e.g., an alphanumeric identifier), a wireline stage the one or more wireline equipment are currently completing or has initiated and/or a wireline stage the one or more wireline equipment have subsequently completed. In some instances, wireline computing system 206 may generate wireline job data 209, automatically. Additionally, or alternatively, wireline computing system 206 may wireline job data 209 based on one or more user inputs provided by one or more operators of wireline computing system 206 and/or operators of each of the one or more wireline equipment.

Additionally, wireline computing system 206 may perform any of the example processes described herein, to among other things, monitor the conditions of each of the one or more wireline equipment. Each of the wireline equipment may include one or more sensors that generate sensor data indicating the conditions of corresponding wireline equipment. Moreover, wireline computing system 206 may determine the conditions of each of the one or more wireline equipment based on associated sensor data. Examples of the conditions include a flow rate or pump rate (e.g., barrels per minute or gallons per minute) of a pump down pump, a pressure (e.g., psi) of the pump down pump, length or depth of a cable of the winch (e.g., based on readings of one or more wheels or circumference), surface tension of a cable of the winch (e.g., based on readings of load cell sensor), drum speed (e.g., revolutions per minute), wireline tool powered on, wireline tool powered off, and a positioning of the wireline tool (e.g., distance from the surface based on one or more locating devices and/or accelerometers attached to the wireline tool). [Further, wireline computing system 206 may generate wireline equipment data 208 based on the determined conditions of each of the one or more fracturing equipment. In some instances, wireline equipment data 208 may, for each of the one or more wireline equipment, identify the corresponding wireline equipment (e.g., an alphanumeric identifier), identify the type of wireline equipment (e.g., pump down pump, winch, or wireline tool), and one or more current conditions of the corresponding wireline equipment (e.g., a current pump rate and/or pressure, surface tension of a cable, downhole tension of a cable, drum speed, whether the wireline tool is powered on or off and/or a positioning of the wireline tool).

Further, wireline computing system 206 may include one or more tangible, non-transitory memories, such as database 207. In some instances, wireline computing system 206 may perform operations that store, within the one or more tangible non-transitory memories of wireline computing system 206, such as database 207, wireline job data 209. In other instances, wireline computing system 206 may perform operations that store, within the one or more tangible non-transitory memories of wireline computing system 206, such as database 207, wireline equipment data 208.

As described herein, fracture crane computing system 210 may perform any of the example processes described herein, to among other things, control and manage a wireline crane, such as fracture crane 108 as illustrated in FIG. 1. In some examples, fracture crane computing system 210 may control a boom of the fracture crane, such as boom 110 as illustrated in FIG. 1. In such examples, fracture crane computing system 210 may control a position/location and/or orientation or heading of the boom. In some instances, fracture crane computing system 210 may control a vertical position of the boom, a horizontal position of the boom, rotational angle of the boom, and boom length of the boom.

Additionally, fracture crane computing system 210 may perform any of the example processes described herein, to among other things, monitor a position and/or orientation of the boom of the fracture crane. As illustrated in FIG. 2, fracture crane computing system 210 may include sensor system 214. In some examples, the sensor system 214 may include one or more sensors or sensor systems, such as a GPS system (e.g., a centimeter precision GPS system) and a magnetometer. Additionally, the one or more sensors or sensor systems may be coupled to the fracture crane, such as on an end of the boom furthest from the operator's cabin of the wireline crane. Moreover, sensor system 214 may generate sensor data indicating a location or position (e.g., geographical coordinates) and/or orientation of the boom of the fracture crane. Further, processor 212 of fracture crane computing system 210 may obtain the sensor data and generate fracture crane position data 216 based on the sensor data. As described herein, fracture crane position data 216 may indicate a current position and/or orientation (e.g., heading) of the boom of the fracture crane. In some instances, fracture crane computing system 210 may perform operations that store, within the one or more tangible non-transitory memories of fracture crane computing system 210, such as database 218, fracture crane position data 216.

As described herein, wireline crane computing system 220 may perform any of the example processes described herein, to among other things, control and manage a wireline crane, such as wireline crane 112 as illustrated in FIG. 1. In some examples, wireline crane computing system 220 may control a boom of the wireline crane, such as boom 114 as illustrated in FIG. 1. In such examples, wireline crane computing system 220 may control the position/location and/or orientation or heading of the boom. In some instances, wireline crane computing system 220 may control a vertical position of the boom, a horizontal position of the boom, a rotational angle of the boom, and boom length of the boom.

Additionally, wireline crane computing system 220 may perform any of the example processes described herein, to among other things, monitor a position and/or orientation of the boom of the wireline crane. As illustrated in FIG. 2, wireline crane computing system 220 may include sensor system 224. In some examples, the sensor system 224 may include one or more sensors or sensor systems, such as a GPS system (e.g., a centimeter precision GPS system) and a magnetometer. Additionally, the one or more sensors or sensor systems may be coupled to the wireline crane, such as on the end of the boom furthest from the operator's cabin of the wireline crane. Moreover, sensor system 224 may generate sensor data indicating a location or position (e.g., geographical coordinates) and/or orientation of the boom of the wireline crane. In some instances, the sensor data may indicate the length and/or the angle of the boom of the wireline crane. Further, processor 228 of wireline crane computing system 220 may obtain the sensor data and generate wireline crane position data 226 based on the sensor data. As described herein, wireline crane position data 226 may indicate a current position and/or orientation (e.g., heading) of the boom of the wireline crane. In some instances, wireline crane computing system 220 may perform operations that store, within the one or more tangible non-transitory memories of wireline crane computing system 220, such as database 228, wireline crane position data 226.

As described herein, wellhead computing system 240 may perform any of the example processes described herein, to among other things, monitor a wellhead of each of one or more wells, such as wellhead 102, wellhead 104 and/or wellhead 106 of FIG. 1. In some examples, wellhead computing system 240 may include sensor system 242. Sensor system 242 may include one or more sensors and may be coupled to a wellhead of each of the one or more wells. For instance, a wellhead may include two actuator valves that control the pressure to open and close a one or more well valves of the wellhead. One or more sensors may be coupled to the two actuator valves that generate sensor data indicating the switch position of the two actuator valves. The sensor data may be utilized by wellhead computing system 240 to determine whether the wellhead is open or closed. The one or more sensors of sensor system 242 may generate sensor data indicating whether the corresponding wellhead is open or closed.

Additionally, sensor system 242 may include additional sensors, such as location-type sensors (e.g., GPS sensors), that may be coupled to a wellhead. The additional sensors of sensor system 242 may generate sensor data indicating a location of the well/wellhead (e.g., geographical coordinates). Additionally, processor 244 of wellhead computing system 240 may obtain the sensor data of sensor system 242 and generate wellhead status data 248. As described herein, wellhead status data 248 may indicate, for the wellhead of each well, whether the wellhead is open or closed, and in some instances, a current location/position of the well (e.g., geographical coordinates). In some instances, processor 244 may perform operations that store, within the one or more tangible non-transitory memories of wellhead computing system 240, such as wellhead database 239, wellhead status data 248.

As described herein, and to perform any of the example processes described herein, well status computing system 230 may maintain, within the one or more tangible, non-transitory memories, a data repository 252 that includes fracturing database 237, wireline database 238238, wellhead database 239, and status database 235. In some instances, fracturing database 237 may store fracturing equipment data 204 and fracturing job data 205 obtained from fracturing computing system 202 and fracture crane position data 216 obtained from fracture crane computing system 210. In other instances, wireline database 238238 may store wireline equipment data 208 and wireline job data 209 obtained from wireline computing system 206 and wireline crane position data 226 obtained from wireline crane computing system 220. In other instances, wellhead database 239 may store wellhead status data 246 obtained from wellhead computing system 240 and status database 235 may store status data generated by well status computing system 230. As described herein status data may include data characterizing, for each well on a drill site, whether the well is in use, the type of use (e.g., fracturing operations/stages or wireline operations/stages) and in some instances whether the well is ready for the next stage of fracturing or wireline stages/operations.

As described herein, at least a processor of well status computing system 230 may execute well status engine 232 to determine a status of each well on a drill site. For instance, and as illustrated in FIG. 1, executed well status engine 232 may determine a status of well of wellhead 102, well of wellhead 104 and well of wellhead 106. Additionally, executed well status engine 232 may determine the status of each well on the drill site based on whether the wellhead is opened or closed. For example, executed well status engine 232 may obtain, over one or more communications networks, such as communications network 250, wellhead status data 246 from wellhead computing system 240. Additionally, executed well status engine 232 may determine whether the well is open or closed based on wellhead status data 246. For instance, referring to FIG. 1, executed well status engine 232 may determine wellhead 102 is open, wellhead 104 is closed and wellhead 106 is open based on corresponding portions of wellhead status data 246. Moreover, executed well status engine 232 may generate status data for each of well of the site. The status data may include data identifying each well of the drill site (e.g., an alphanumeric identifier) and data characterizing whether the corresponding well is open or closed. In some instances, executed well status engine 232 may perform operations that store, within the one or more tangible non-transitory memories of well status computing system 230, such as wellhead database 239 and status database 240, wellhead status data 246 and the status data, respectively.

Additionally, executed well status engine 232 may determine a status of each of well on a drill site based on a positioning/location and orientation of a wireline crane and fracture crane relative to the well. In some examples, executed well status engine 232 may obtain, over one or more communications networks, such as communications network 250, fracture crane position data 216 obtained from fracture crane computing system 210. Additionally, executed well status engine 232 may determine a location/position and/or an orientation of a boom of a fracture crane, such as boom 110 of fracture crane 108 of FIG. 1, based on fracture crane position data 216. Moreover, may obtain, over one or more communications networks, such as communications network 250, wellhead status data 246 from wellhead computing system 240. Executed well status engine 232 may determine, for each well for the drill site, the location of the well/wellhead. Based on the determined location for each well and the determined location/position and/or orientation of a boom of a fracture crane, executed well status engine 232 may determine the location/position and/or orientation of the boom of the fracture crane relative to each well. Further, executed well status engine 232 may generate additional status data. The additional status data may include data identifying and characterizing the location/position and/or orientation of the boom of the fracture crane relative to each well, and a corresponding identifier of each well (e.g., an alphanumeric identifier). In some instances, executed well status engine 232 may perform operations that store, within the one or more tangible non-transitory memories of well status computing system 230 well status computing system 230, such as status database 235, the additional status data.

By way of example, and with reference to FIG. 1, executed well status engine 232 may determine a location or position of wellhead 104 based on portions of wellhead status data 246 associated with wellhead 104. Additionally, executed well status engine 232 may determine a location/position and/or orientation of boom 110 of fracture crane 108. Moreover, executed well status engine 232 may determine the determined location or position of wellhead 104 and the determined location/position and/or orientation of boom 110 of fracture crane 108 do not overlap. Based on determining the determined location or position of wellhead 104 and the determined location/position and/or orientation of boom 110 of fracture crane 108 do not overlap, executed well status engine 232 may determine that boom 110 of fracture crane 108 is not positioned over wellhead 104. In another example, executed well status engine 232 may determine a location or position of wellhead 106 based on portions of wellhead status data 246 associated with wellhead 106. Additionally, executed well status engine 232 may determine a location/position and/or orientation of boom 110 of fracture crane 108. Moreover, executed well status engine 232 may determine the determined location or position of wellhead 106 and the determined location/position and/or orientation of boom 110 of fracture crane 108 do overlap. Based on determining the determined location or position of wellhead 106 and the determined location/position and/or orientation of boom 110 of fracture crane 108 do overlap, executed well status engine 232 may determine that boom 110 of fracture crane 108 is positioned over wellhead 106.

In other instances, executed well status engine 232 may determine whether the boom of the fracture crane is position over a well upon determining the boom of the fracture crane is positioned over the well for a predetermined threshold time. In such instances, sensor data generated by sensor system 214 may indicate, for each unit of time (e.g., per second), a location/position and/or orientation of the boom of the fracture crane. For instance, the sensor data may include a set of geographical coordinates that each indicate a location/position of the boom of the fracture crane. Additionally, the sensor data may include, for each geographical coordinate, a timestamp representative of when the geographical coordinate was captured by the one or more sensors of sensor system 214. Moreover, the sensor data may include a set of directional headings (e.g., a data point in a three-dimensional space) indicating an orientation or heading of the boom of the fracture crane. Further, the sensor data may include, for each of the set of directional headings, a timestamp representative of when the directional heading was captured by the one or more sensors of sensor system 214. Processor 212 of fracture crane computing system 210 may match each geographical coordinate and directional heading based on matching timestamps. As such, the fracture crane position data 216 may include a record of positions/locations of the boom of the fracture crane. The record may include a set of entries and each entry may include a position/location and/or orientation of the boom of the fracture crane a particular time and a timestamp indicating the particular time.

Additionally, executed well status engine 232 may determine a position of the boom of the fracture crane at various points in time based on fracture crane position data 216. Moreover, executed well status engine 232 may determine the duration of time the boom of the fracture crane is over a well based on wellhead status data 246 and fracture crane position data 216. In some instances, executed well status engine 232 may determine the boom of the fracture crane is not positioned over the well upon determining the duration of time the boom of the fracture crane is over the well is less than a predetermined threshold time. In other instances, executed well status engine 232 may determine the boom of the fracture crane is positioned over the well upon determining the duration of time the boom of the fracture crane is over the well is equal to or more than a predetermined threshold time.

In other examples, executed well status engine 232 may obtain, over one or more communications networks, such as communications network 250, wireline crane position data 226 obtained from wireline crane computing system 220. Additionally, executed well status engine 232 may determine a location/position and/or an orientation of a boom of a wireline crane, such as boom 114 of wireline crane 112 of FIG. 1, based on wireline crane position data 226. Moreover, may obtain, over one or more communications networks, such as communications network 250, wellhead status data 246 from wellhead computing system 240. Executed well status engine 232 may determine, for each well for a drill site, the location of the well/wellhead. Based on the determined location for a particular well and the determined location/position and/or orientation of a boom of a fracture crane, executed well status engine 232 may determine a position/location and/or orientation of the boom of the wireline crane relative to each well. Further, executed well status engine 232 may generate additional status data. The additional status data may include data identifying and characterizing a location/position and/or orientation of the boom of the wireline crane relative to each well, and a corresponding identifier of each well (e.g., an alphanumeric identifier). In some instances, executed well status engine 232 may perform operations that store, within the one or more tangible non-transitory memories of well status computing system 230, such as status database 235, the additional status data.

By way of example, and with reference to FIG. 1, executed well status engine 232 may determine a location or position of wellhead 104 based on portions of wellhead status data 246 associated with wellhead 104. Additionally, executed well status engine 232 may determine a location/position and/or orientation of boom 114 of wireline crane 112. Moreover, executed well status engine 232 may determine the determined location or position of wellhead 104 and the determined location/position and/or orientation of boom 114 of wireline crane 112 do not overlap. Based on determining the determined location or position of wellhead 104 and the determined location/position and/or orientation of boom 114 of wireline crane 112 do not overlap, executed well status engine 232 may determine that boom 114 of wireline crane 112 is not positioned over wellhead 104. In another example, executed well status engine 232 may determine a location or position of wellhead 102 based on portions of wellhead status data 246 associated with wellhead 102. Additionally, executed well status engine 232 may determine a location/position and/or orientation of boom 114 of wireline crane 112 based on wireline crane position data 226. Moreover, executed well status engine 232 may determine the determined location or position of wellhead 102 and the determined location/position and/or orientation of boom 114 of wireline crane 112 overlap. Based on the determining the determined location or position of wellhead 102 and the determined location/position and/or orientation of boom 114 of wireline crane 112 overlap, executed well status engine 232 may determine that boom 114 of wireline crane 112 is positioned over wellhead 102.

In other instances, executed well status engine 232 may determine whether the boom of the wireline crane is position over a well upon determining the boom of the wireline crane is positioned over the well for a predetermined time. In such instances, sensor data generated by sensor system 224 may indicate, for each unit of time (e.g., per second), a location/position and/or orientation of the boom of the wireline crane. For instance, the sensor data may include a set of geographical coordinates that each indicate a location/position of the boom of the wireline crane. Additionally, the sensor data may include, for each geographical coordinate, a timestamp representative of when the geographical coordinate was captured by the one or more sensors of sensor system 224. Moreover, the sensor data may include a set of directional headings (e.g., a data point in a three-dimensional space) indicating an orientation or heading of the boom of the wireline crane. Further, the sensor data may include, for each of the set of directional headings, a timestamp representative of when the directional heading was captured by the one or more sensors of sensor system 224. Processor 228 of wireline crane computing system 220 may match each geographical coordinate and directional heading based on matching timestamps. As such, the wireline crane position data 226 may include a record of positions/locations of the boom of the wireline crane. The record may include a set of entries and each entry may include a position/location and/or orientation of the boom of the wireline crane a particular time and a timestamp indicating the particular time.

Additionally, executed well status engine 232 may determine a position of the boom of the wireline crane at various points in time based on wireline crane position data 226. Moreover, executed well status engine 232 may determine the amount of time the boom of the wireline crane is over a well based on wellhead status data 246 and wireline crane position data 226. In some instances, executed well status engine 232 may determine the boom of the wireline crane is not positioned over the well upon determining the duration of time the boom of the fracture crane is over the well is less than a predetermined threshold time. In other instances, executed well status engine 232 may determine the boom of the wireline crane is positioned over the well upon determining the duration of time the boom of the wireline crane is over the well is equal to or more than a predetermined threshold time.

A. Example Processes for Determining a Status of a Well when the Well is Closed with a Fracture Crane Positioned Over the Well.

In some examples, well status computing system 230 may determine a status of a well based on determining the well is closed and a fracture crane is positioned over the well. As described herein, executed well status engine 232 may perform the example processes described herein, to, among other things, determine the well is closed and the fracture crane is positioned over the well. In some instances, executed well status engine 232 may also perform example processes described herein, among other things, to additionally determine the wireline crane is not positioned over the well.

Additionally, executed well status engine 232 may determine whether a wireline stage of a set of wireline stages has been completed for the well based on determining the well is closed, the fracture crane is positioned over the well, and in some instances, the wireline crane is not positioned over the well. For example, executed well status engine 232 may obtain, over one or more communications networks, such as communications network 250, wireline job data 209 from wireline computing system 206. Additionally, executed well status engine 232 may parse wireline job data 209 to identify, for the well, the status of a wireline stage. Moreover, executed well status engine 232 determine whether the wireline stage has been initiated, the wireline stage is currently being completed, or the wireline stage is completed based on the identified status of the wireline stage.

In some instances, executed well status engine 232 may determine a wireline stage is currently being completed or has been initiated for the well. In such instances, executed well status engine 232 may determine the well is not ready for a fracture stage. Additionally, executed well status engine 232 may generate additional status data indicating the well is not ready for a fracture stage. Moreover, executed well status engine 232 may generate a notification and package one or more portions of the status data. The one or more portions of the status data may identify the well (e.g., an alphanumeric identifier) and indicate that the well is not ready for a fracture stage. Further, executed well status engine 232 may cause well status computing system 230 to generate a GUI along with one or more interface elements that present information based on the notification. For instance, the one or more interface elements may present information that the well is not ready for the fracture stage. In some instances, executed well status engine 232 may perform operations that store, within the one or more tangible non-transitory memories of well status computing system 230, such as status database 240 and wireline database 238, the additional status data and wireline job data 209, respectively.

In other instances, executed well status engine 232 may determine a wireline stage is completed for the well. In such instances, executed well status engine 232 may determine pressure conditions of one or more pumps of the fracture equipment at the well. For example, executed well status engine 232 may obtain, over one or more communications networks, such as communications network 250, fracturing equipment data 204 from fracturing computing system 202. Additionally, executed well status engine 232 may parse fracturing equipment data 204 to identify, for each of pump identified in equipment data, one or more current conditions of each pump, such as the current pressure level of each pump. Moreover, executed well status engine 232 may determine whether the pressure of the wellhead has been equalized based on a comparison between the current pressure level of each pump and a threshold pressure level (e.g., psi).

In some instances, executed well status engine 232 may determine the current pressure levels of each pump is greater than the threshold pressure level. In such instances, executed well status engine 232 may determine the fracture crane is positioned over the well and the pressure of the wellhead is not yet equalized. Additionally, executed well status engine 232 may generate additional status data indicating the fracture crane is positioned over the well and the pressure of the wellhead is not yet equalized. Moreover, executed well status engine 232 may generate a notification and package one or more portions of the status data. The one or more portions of status data may identify the well (e.g., an alphanumeric identifier) and indicate that the fracture crane is positioned over the well and the pressure of the wellhead is not yet equalized. Further, executed well status engine 232 may cause well status computing system 230 to generate a GUI along with one or more interface elements that present information based on the notification. For instance, the one or more interface elements may present information that the fracture crane is positioned over the well and the pressure of the wellhead is not yet equalized. In some instances, executed well status engine 232 may perform operations that store, within the one or more tangible non-transitory memories of well status computing system 230, such as status database 240 and fracturing database 254, the additional status data and fracturing equipment data 204, respectively.

In other instances, executed well status engine 232 may determine the current pressure levels of each pump is equal to or less than the threshold pressure level. In such instances, executed well status engine 232 may determine the fracture crane is positioned over the well and the pressure of the wellhead is equalized. Additionally, executed well status engine 232 may generate additional status data indicating the fracture crane is positioned over the well and the pressure of the wellhead is equalized. Moreover, executed well status engine 232 may generate a notification and package one or more portions of status data. The one or more portions of status data may identify the well (e.g., an alphanumeric identifier) and indicate that the fracture crane is positioned over the well and the pressure of the wellhead is equalized. Further, executed well status engine 232 may cause well status computing system 230 to generate a GUI along with one or more interface elements that present information based on the notification. For instance, the one or more interface elements may present information that the fracture crane is positioned over the well and the pressure of the wellhead is equalized. In some instances, executed well status engine 232 may perform operations that store, within the one or more tangible non-transitory memories of well status computing system 230, such as status database 240 and fracturing database 254, the additional status data and fracturing equipment data 204, respectively.

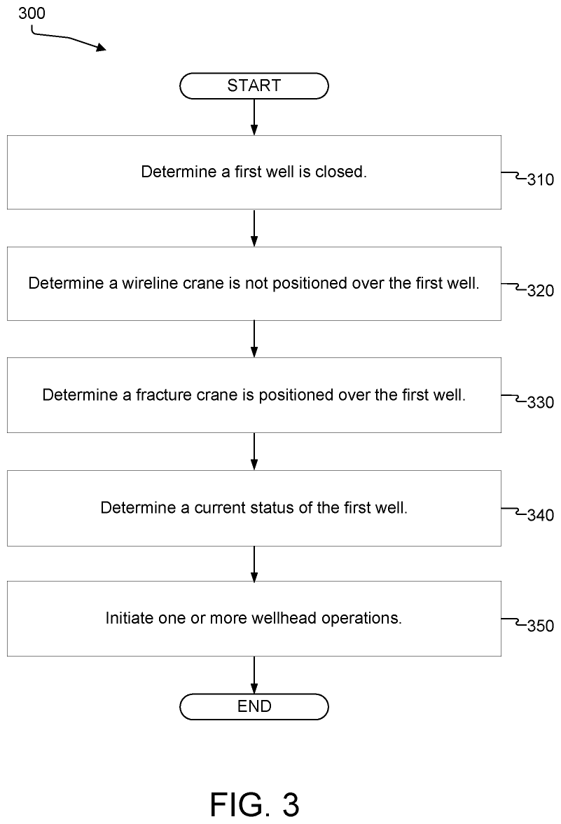

FIG. 3 is a flow chart of an example process 300 for determining a status of a well that is closed with a fracture crane positioned over the well and performing one or more wellhead operations associated with the status. In some instances, one or more components of computing environment 200 may perform all or a portion of the steps of example process 300, which include but are not limited to determining a first well is closed, determining a wireline crane is not positioned over the first well, determining a fracture crane is positioned over the first well, determining a current status of the first well, and initiating one or more wellhead operations.

Referring to FIG. 3, well status computing system 230 may determine a first well is closed (e.g., step 310). In some examples, executed well status engine 232 may obtain, over one or more communications networks, such as communications network 250, wellhead status data 246 from wellhead computing system 240. Additionally, executed well status engine 232 may determine whether a well is closed based on a corresponding portion of wellhead status data 246. For instance, referring to FIG. 1, executed well status engine 232 may determine wellhead 106 is closed based on corresponding portions of wellhead status data 246.

Referring to FIG. 3, well status computing system 230 may determine a wireline crane is not positioned over the first well (e.g., step 320). In some examples, executed well status engine 232 may obtain, over one or more communications networks, such as communications network 250, wireline crane position data 226 obtained from wireline crane computing system 220. Additionally, executed well status engine 232 may determine a location/position and/or an orientation of a boom of a wireline crane, such as boom 114 of wireline crane 112 of FIG. 1, based on wireline crane position data 226. Moreover, executed well status engine 232 may obtain, over one or more communications networks, such as communications network 250, wellhead status data 246 from wellhead computing system 240. Executed well status engine 232 may determine, for the well, the location of the well/wellhead. Based on the determined location for the well and the determined location/position and/or orientation of a boom of a fracture crane, executed well status engine 232 may determine a position/location and/or orientation of the boom of the wireline crane relative to the well (e.g., whether the boom of the wireline crane is positioned over the well). In some instances, executed well status engine 232 may determine whether a wireline crane is positioned over the first well based on determining the first well is closed.

Referring to FIG. 3, well status computing system 230 may determine a fracture crane is positioned over the first well (e.g., step 330). In some examples, executed well status engine 232 may obtain, over one or more communications networks, such as communications network 250, fracture crane position data 216 obtained from fracture crane computing system 210. Additionally, executed well status engine 232 may determine a location/position and/or an orientation of a boom of a fracture crane, such as boom 110 of fracture crane 108 of FIG. 1, based on fracture crane position data 216. Moreover, executed well status engine 232 may obtain, over one or more communications networks, such as communications network 250, wellhead status data 246 from wellhead computing system 240. Executed well status engine 232 may determine, for the well, the location of the well/wellhead. Based on the determined location for the well and the determined location/position and/or orientation of a boom of a fracture crane, executed well status engine 232 may determine the location/position and/or orientation of the boom of the fracture crane relative to the well. In some instances, executed well status engine 232 may determine whether a fracture crane is positioned over the first well based on determining the wireline crane is not positioned over the first well.

Referring to FIG. 3, well status computing system 230 may determine a current status of the first well (e.g., step 540). In some examples, executed well status engine 232 may determine whether a wireline stage of a set of wireline stages has been completed for the well based on determining the well is closed, the fracture crane is positioned over the well, and the wireline crane is not positioned over the well. For example, executed well status engine 232 may obtain, over one or more communications networks, such as communications network 250, wireline job data 209 from wireline computing system 206. Additionally, executed well status engine 232 may parse wireline job data 209 to identify, for the well, the status of a wireline stage. Moreover, executed well status engine 232 determine whether the wireline stage has been initiated, the wireline stage is currently being completed, or the wireline stage is completed based on the identified status of the wireline stage.

In some instances, executed well status engine 232 may determine a wireline stage is currently being completed or has been initiated for the well. In such instances, executed well status engine 232 may determine the well is not ready for a fracture stage. Additionally, executed well status engine 232 may generate additional status data indicating the well is not ready for a fracture stage. In other instances, executed well status engine 232 may determine a wireline stage is completed for the well. In such instances, executed well status engine 232 may determine pressure conditions of one or more pumps of the fracture equipment at the well. For example, executed well status engine 232 may obtain, over one or more communications networks, such as communications network 250, fracturing equipment data 204 from fracturing computing system 202. Additionally, executed well status engine 232 may parse fracturing equipment data 204 to identify, for each of pump identified in equipment data, one or more current conditions of each pump, such as the current pressure level of each pump. Moreover, executed well status engine 232 may determine whether the pressure of the wellhead has been equalized based on a comparison between the current pressure level of each pump and a threshold pressure level (e.g., psi).

In various instances, executed well status engine 232 may determine the current pressure level of each pump is greater than the threshold pressure level. In such instances, executed well status engine 232 may determine the fracture crane is positioned over the well and the pressure of the wellhead is not yet equalized. Additionally, executed well status engine 232 may generate additional status data indicating the fracture crane is positioned over the well and the pressure of the wellhead is not yet equalized. In other instances, executed well status engine 232 may determine the current pressure level of each pump is equal to or less than the threshold pressure level. In such instances, executed well status engine 232 may determine the fracture crane is positioned over the well and the pressure of the wellhead is equalized. Additionally, executed well status engine 232 may generate additional status data indicating the fracture crane is positioned over the well and the pressure of the wellhead is equalized.

Referring to FIG. 3, well status computing system 230 may initiate one or more wellhead operations (e.g., step 350). In some examples, executed well status engine 232 may cause a display (e.g., a display of well status computing system 230 or a display of another computing device) to present information included in the status data. For instance, the status data may identify the well (e.g., an alphanumeric identifier) and indicate that the well is not ready for a fracture stage. Additionally, executed well status engine 232 may cause well status computing system 230 to generate a GUI along with one or more interface elements that present information based on the status data. The one or more interface elements may present information that the well is not ready for the fracture stage.

In another instance, the status data may identify the well (e.g., an alphanumeric identifier) and indicate that the fracture crane is positioned over the well and the pressure of the wellhead is not yet equalized. Additionally, executed well status engine 232 may cause well status computing system 230 to generate a GUI along with one or more interface elements that present information based on the status data. The one or more interface elements may present information that the fracture crane is positioned over the well and the pressure of the wellhead is not yet equalized.

In another instance, the status data may identify the well (e.g., an alphanumeric identifier) and indicate that the fracture crane is positioned over the well and the pressure of the wellhead is equalized. Additionally, executed well status engine 232 may cause well status computing system 230 to generate a GUI along with one or more interface elements that present information based on the status data. The one or more interface elements may present information that the fracture crane is positioned over the well and the pressure of the wellhead is equalized.

B. Example Processes for Determining a Status of a Well when the Well is Closed with a Wireline Crane Positioned Over the Well.

In some examples, well status computing system 230 may determine a status of a well based on determining the well is closed and a wireline crane is positioned over the well. As described herein, executed well status engine 232 may perform the example processes described herein, among other things, to determine the well is closed and the wireline crane is positioned over the well. In some instances, executed well status engine 232 may perform example processes described herein, among other things, to additionally determine the fracture crane is not positioned over the well.

Additionally, executed well status engine 232 may determine whether a fracture stage has been completed for the well based on determining the well is closed, the wireline crane is positioned over the well, and in some instances, the fracture crane is not positioned over the well. For example, executed well status engine 232 may obtain, over one or more communications networks, such as communications network 250, fracturing job data 205 from wireline computing system 206. Additionally, executed well status engine 232 may parse fracturing job data 205 to identify, for the well, the status of a fracture stage or operation. Moreover, executed well status engine 232 may determine whether the fracture stage has been initiated, the fracture stage is currently being completed, or the fracture stage is completed for the well.

In some instances, executed well status engine 232 may determine a fracture stage is currently being completed or has been initiated for the well. In such instances, executed well status engine 232 may determine the well is not ready for a wireline stage or operation. Additionally, executed well status engine 232 may generate additional status data indicating the well is not ready for a wireline stage or operation. Moreover, executed well status engine 232 may generate a notification and package one or more portions of status data. The one or more portions of status data may identify the well (e.g., an alphanumeric identifier) and indicate that the well is not ready for a wireline stage or operation. Further, executed well status engine 232 may cause well status computing system 230 to generate a GUI along with one or more interface elements that present information based on the notification. For instance, the one or more interface elements may present information that the well is not ready for the wireline stage or operations. In some instances, executed well status engine 232 may perform operations that store, within the one or more tangible non-transitory memories of well status computing system 230, such as status database 240 and wireline database 238, the additional status data and fracturing job data 205, respectively.

In other instances, executed well status engine 232 may determine a fracture stage has been or has just completed for the well. In such instances, executed well status engine 232 may determine whether the cable of the winch is in the process of being rigged into the well. For instance, executed well status engine 232 may obtain, over one or more communications networks, such as communications network 250, wireline equipment data 208 from wireline computing system 206. Additionally, executed well status engine 232 may parse wireline equipment data 208 to identify a surface tension of a cable of the winch. Moreover, executed well status engine 232 may compare the surface tension of the cable of the winch to a threshold surface tension value or weight (e.g., lbs). Based on the comparison, executed well status engine 232 may determine whether wireline is in the process of rigging into the well.

In some instance, based on the comparison, executed well status engine 232 may determine the surface tension of the cable of the winch is less than the threshold surface tension value. Additionally, executed well status engine 232 may determine the cable of the winch is in the process of being rigged into the well. Moreover, executed well status engine 232 may generate additional status data indicating the well is in the process of having a cable of the winch rigged into the well. Further, executed well status engine 232 may generate a notification and package one or more portions of status data. The one or more portions of status data may identify the well (e.g., an alphanumeric identifier) and indicate that the cable of the winch is in the process of being rigged into the well. In some instances, executed well status engine 232 may cause well status computing system 230 to generate a GUI along with one or more interface elements that present information based on the notification. For instance, the one or more interface elements may present information that the cable of the winch is in the process of being rigged into the well. In some instances, executed well status engine 232 may perform operations that store, within the one or more tangible non-transitory memories of well status computing system 230, such as status database 240 and wireline database 238, the additional status data and wireline equipment data 208, respectively.

In other instances, based on the comparison, executed well status engine 232 may determine the surface tension of the cable of the winch is more than or equal to the threshold surface tension value. In such instances, executed well status engine 232 may determine whether the pressure of the wellhead is equalized. For example, executed well status engine 232 may obtain, over one or more communications networks, such as communications network 250, wireline equipment data 208 from wireline computing system 206. Additionally, executed well status engine 232 may parse wireline equipment data 208 to identify, for each of pump down pump identified in wireline equipment data 208, one or more current conditions of each pump down pump, such as the current pressure level of each pump down pump. Moreover, executed well status engine 232 may determine whether the pressure of the wellhead has been equalized based on a comparison between the current pressure level of each pump down pump and a threshold pressure level (e.g., psi).

In some instances, executed well status engine 232 may determine the current pressure level of each pump down pump is greater than the threshold pressure level. In such instances, executed well status engine 232 may determine the wireline crane is positioned over the well and the pressure of the wellhead is not yet equalized. Additionally, executed well status engine 232 may generate additional status data indicating the wireline crane is positioned over the well and the pressure of the wellhead is not yet equalized. Moreover, executed well status engine 232 may generate a notification and package one or more portions of status data. The one or more portions of status data may identify the well (e.g., an alphanumeric identifier) and indicate that the wireline crane is positioned over the well and the pressure of the wellhead is not yet equalized. Further, executed well status engine 232 may cause well status computing system 230 to generate a GUI along with one or more interface elements that present information based on the notification. For instance, the one or more interface elements may present information that the wireline crane is positioned over the well and the pressure of the wellhead is not yet equalized. In some instances, executed well status engine 232 may perform operations that store, within the one or more tangible non-transitory memories of well status computing system 230, such as status database 240 and wireline database 238, the additional status data and wireline equipment data 208, respectively.

In other instances, executed well status engine 232 may determine the current pressure level of each pump down pump is equal to or less than the threshold pressure level. In such instances, executed well status engine 232 may determine the wireline crane is positioned over the well and the pressure of the wellhead is equalized. Additionally, executed well status engine 232 may generate additional status data indicating the wireline crane is positioned over the well and the pressure of the wellhead is equalized. Moreover, executed well status engine 232 may generate a notification and package one or more portions of status data. The one or more portions of status data may identify the well (e.g., an alphanumeric identifier) and indicate that the wireline crane is positioned over the well and the pressure of the wellhead is equalized. Further, executed well status engine 232 may cause well status computing system 230 to generate a GUI along with one or more interface elements that present information based on the notification. For instance, the one or more interface elements may present information that the fracture crane is positioned over the well and the pressure of the wellhead is equalized. In some instances, executed well status engine 232 may perform operations that store, within the one or more tangible non-transitory memories of well status computing system 230, such as status database 240 and wireline database 238, additional status data and wireline equipment data 208, respectively.

In other examples, the example processes describe herein that executed well status engine 232 may perform to determine the well is closed and the fracture crane or wireline crane is positioned over the well includes determining an amount of time the well has been closed. In such instances, executed well status engine 232 may determine the position/location and/or orientation of the wireline crane and/or fracture crane relative to the well based on the amount of time the well has been closed. In some examples, wellhead status data 248 may include information that identifies and characterizes, for each wellhead of each well, each instance the corresponding wellhead was opened or closed and a timestamp indicting a time when the wellhead was opened or closed. In such examples, executed well status engine 232 may, obtain, over one or more communications networks, such as communications network 250, wellhead status data 248. Additionally, executed well status engine 232 may determine the amount of time a well has been closed based on the wellhead status data 248. Moreover, executed well status engine 232 may perform any of the example processes describe herein, to among other things, determine the wireline crane and/or the fracture crane is positioned over the well based on a comparison between the amount of time a well has been closed and a predetermined time threshold (e.g., seconds).

In some instances, executed well status engine 232 may determine the amount of time a well has been closed is less than a predetermined time threshold. In such instances, executed well status engine 232 may perform any of the example processes describe herein, to among other things, determine the wireline crane and/or the fracture crane is positioned over the well based on a comparison between the amount of time a well has been closed and a predetermined time threshold (e.g., seconds). In other instances, executed well status engine 232 may determine the amount of time a well has been closed is greater than or equal to a predetermined time threshold. In such instances, executed well status engine 232 may determine the well is closed and in the process of returning to safe conditions. Additionally, executed well status engine 232 may generate status data based on the determinations. Moreover, executed well status engine 232 may generate a notification and package one or more portions of status data. The one or more portions of status data may include an identifier of the well (e.g., an alphanumeric identifier) and data indicating that the well is closed and in the process of returning to safe conditions. Further, executed well status engine 232 may cause well status computing system 230 to generate a GUI along with one or more interface elements that present information based on the notification. For instance, the one or more interface elements may present information that the well is closed and in the process of returning to safe conditions. In some instances, executed well status engine 232 may perform operations that store, within the one or more tangible non-transitory memories of well status computing system 230, such as status database 240, additional status data.

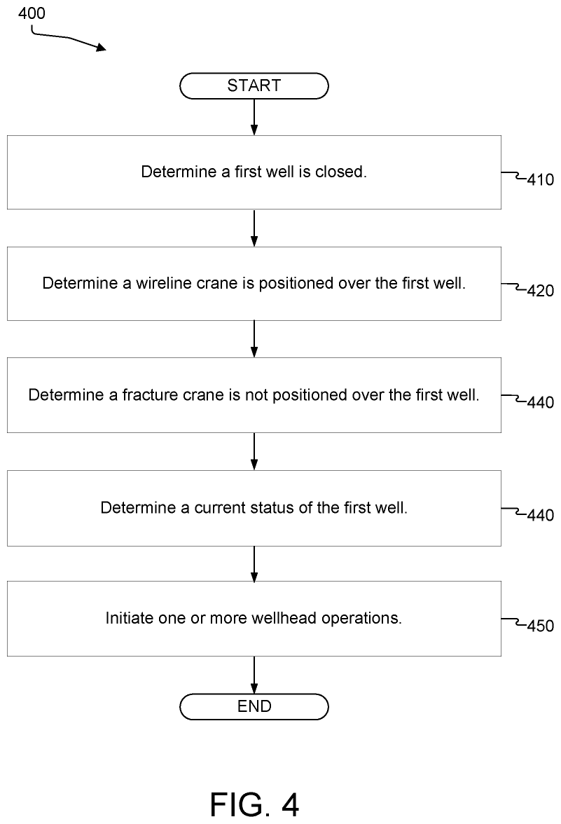

FIG. 4 is a flow chart of an example process 400 for determining a status of a well that is closed with a wireline crane positioned over the well and performing one or more wellhead operations associated with the status. In some instances, one or more components of computing environment 200 may perform all or a portion of the steps of example process 400, which include but are not limited to determining a first well is closed, determining a wireline crane is positioned over the first well, determining a fracture crane is not positioned over the first well, determining a current status of the first well, and initiating one or more wellhead operations.

Referring to FIG. 4, well status computing system 230 may determine a first well is closed (e.g., step 410). In some examples, executed well status engine 232 may obtain, over one or more communications networks, such as communications network 250, wellhead status data 246 from wellhead computing system 240. Additionally, executed well status engine 232 may determine whether a well is closed based on a corresponding portion of wellhead status data 246. For instance, referring to FIG. 1, executed well status engine 232 may determine wellhead 102 is closed based on corresponding portions of wellhead status data 246.

Referring to FIG. 4, well status computing system 230 may determine a wireline crane is positioned over the first well (e.g., 420). In some examples, executed well status engine 232 may obtain, over one or more communications networks, such as communications network 250, wireline crane position data 226 obtained from wireline crane computing system 220.

Additionally, executed well status engine 232 may determine a location/position and/or an orientation of a boom of a wireline crane, such as boom 114 of wireline crane 112 of FIG. 1, based on wireline crane position data 226. Moreover, executed well status engine 232 may obtain, over one or more communications networks, such as communications network 250, wellhead status data 246 from wellhead computing system 240. Executed well status engine 232 may determine, for the well, the location of the well/wellhead. Based on the determined location for the well and the determined location/position and/or orientation of a boom of a fracture crane, executed well status engine 232 may determine a position/location and/or orientation of the boom of the wireline crane relative to the well (e.g., whether the boom of the wireline crane is positioned over the well). In some instances, executed well status engine 232 may determine whether a wireline crane is positioned over the first well based on determining the first well is closed.

Referring to FIG. 4, well status computing system 230 may determine a fracture crane is not positioned over the first well (e.g., step 430). In some examples, executed well status engine 232 may obtain, over one or more communications networks, such as communications network 250, fracture crane position data 216 obtained from fracture crane computing system 210. Additionally, executed well status engine 232 may determine a location/position and/or an orientation of a boom of a fracture crane, such as boom 110 of fracture crane 108 of FIG. 1, based on fracture crane position data 216. Moreover, executed well status engine 232 may obtain, over one or more communications networks, such as communications network 250, wellhead status data 246 from wellhead computing system 240. Executed well status engine 232 may determine, for the well, the location of the well/wellhead. Based on the determined location for the well and the determined location/position and/or orientation of a boom of a fracture crane, executed well status engine 232 may determine the location/position and/or orientation of the boom of the fracture crane relative to the well. In some instances, executed well status engine 232 may determine whether a fracture crane is positioned over the first well based on determining the wireline crane is not positioned over the first well.

Referring to FIG. 4, well status computing system 230 may determine a current status of the first well (e.g., step 440). In some examples, executed well status engine 232 may determine whether a fracture stage has been completed for the well based on determining the well is closed, the wireline crane is positioned over the well, and in some instances, the fracture crane is not positioned over the well. In some instances, executed well status engine 232 may determine a fracture stage is currently being completed or has been initiated for the well. In such instances, executed well status engine 232 may determine the well is not ready for a wireline stage or operation. Additionally, executed well status engine 232 may generate additional status data indicating the well is not ready for a wireline stage or operation.

In other instances, executed well status engine 232 may determine a fracture stage has been or has just completed for the well. In such instances, executed well status engine 232 may determine whether the cable of the winch is in the process of being rigged into the well. In various instances, based on the comparison, executed well status engine 232 may determine the surface tension of the cable of the winch is less than the threshold surface tension value. Additionally, executed well status engine 232 may determine the cable of the winch is in the process of being rigged into the well. Moreover, executed well status engine 232 may generate additional status data indicating the well is in the process of having a cable of the winch rigged into the well.

In some instances, based on the comparison, executed well status engine 232 may determine the surface tension of the cable of the winch is more than or equal to the threshold surface tension value. In such instances, executed well status engine 232 may determine whether the pressure of the wellhead is equalized. In other instances, executed well status engine 232 may determine the current pressure level of each pump down pump is greater than the threshold pressure level. In such instances, executed well status engine 232 may determine the wireline crane is positioned over the well and the pressure of the wellhead is not yet equalized. Additionally, executed well status engine 232 may generate additional status data indicating the wireline crane is positioned over the well and the pressure of the wellhead is not yet equalized.

In various instances, executed well status engine 232 may determine the current pressure level of each pump down pump is equal to or less than the threshold pressure level. In such instances, executed well status engine 232 may determine the wireline crane is positioned over the well and the pressure of the wellhead is equalized. Additionally, executed well status engine 232 may generate additional status data indicating the wireline crane is positioned over the well and the pressure of the wellhead is equalized.

Referring to FIG. 4, well status computing system 230 may initiate one or more wellhead operations (e.g., step 440). In some examples, executed well status engine 232 may cause a display (e.g., a display of well status computing system 230 or a display of another computing device) to present information included in the status data. In some instances, the status data may identify the well (e.g., an alphanumeric identifier) and indicate that the well is not ready for a wireline stage or operation. Additionally, executed well status engine 232 may cause well status computing system 230 to generate a GUI along with one or more interface elements that present information based on the status data. The one or more interface elements may present information that the well is not ready for the wireline stage or operations.

In other instances, the status data may identify the well (e.g., an alphanumeric identifier) and indicate that the cable of the winch is in the process of being rigged into the well. Additionally, executed well status engine 232 may cause well status computing system 230 to generate a GUI along with one or more interface elements that present information based on the status data. The one or more interface elements may present information that the cable of the winch is in the process of being rigged into the well.

In various instances, the status data may identify the well (e.g., an alphanumeric identifier) and indicate that the wireline crane is positioned over the well and the pressure of the wellhead is not yet equalized. Additionally, executed well status engine 232 may cause well status computing system 230 to generate a GUI along with one or more interface elements that present information based on the status data. The one or more interface elements may present information that the wireline crane is positioned over the well and the pressure of the wellhead is not yet equalized.

In some instances, the status data may identify the well (e.g., an alphanumeric identifier) and indicate that the wireline crane is positioned over the well and the pressure of the wellhead is equalized. Additionally, executed well status engine 232 may cause well status computing system 230 to generate a GUI along with one or more interface elements that present information based on the status data. For instance, the one or more interface elements may present information that the fracture crane is positioned over the well and the pressure of the wellhead is equalized.

C. Example Processes for Determining a Status of a Well where the Well is Open with a Fracture Crane Positioned Over the Well.

In some examples, well status computing system 230 may determine a status of a well based on determining the well is open and a fracture crane is positioned over the well. As described herein, executed well status engine 232 may perform example processes described herein, among other things, to determine the well is open and the fracture crane is positioned over the well. In some instances, executed well status engine 232 may perform example processes described herein, among other things, to additionally determine the wireline crane is not positioned over the well.

Additionally, executed well status engine 232 may determine whether a fracture stage has initiated or is in progress and whether the one or more pumps of the fracturing equipment is active based on determining the well is open, the fracture crane is positioned over the well and, in some instances, the wireline crane is not positioned over the well. For instance, executed well status engine 232 may obtain, over one or more communications networks, such as communications network 250, fracturing equipment data 204 from fracturing computing system 202. Additionally, executed well status engine 232 may parse fracturing equipment data 204 to identify each pump in fracturing equipment data 204. Moreover, executed well status engine 232 may, for each of pump identified in fracturing equipment data 204, determine a current flow rate or pump rate based on fracturing equipment data 204. Further, executed well status engine 232 may determine whether the one or more pumps is active based on a comparison between the current flow rate or pump rate of each pump and a threshold current flow rate or pump rate (e.g., psi).

In some instances, executed well status engine 232 may determine the current flow rate or pump rate of each pump is greater than or equal to the threshold current flow rate or pump rate. In such instances, executed well status engine 232 may determine a fracture stage has initiated or is in progress and the one or more pumps of the fracturing equipment is active. Additionally, executed well status engine 232 may generate additional status data indicating the fracture stage has initiated or is in progress and the one or more pumps is active. Moreover, executed well status engine 232 may generate a notification and package one or more portions of status data. The one or more portions of status data may identify the well (e.g., an alphanumeric identifier) and indicate that the fracture stage has initiated or is in progress and the one or more pumps is active. Further, executed well status engine 232 may cause well status computing system 230 to generate a GUI along with one or more interface elements that present information based on the notification. For instance, the one or more interface elements may present information that the fracture stage has initiated or is in progress and the one or more pumps. In some instances, executed well status engine 232 may perform operations that store, within the one or more tangible non-transitory memories of well status computing system 230, such as status database 240 and fracturing database 254, additional status data and fracturing equipment data 204, respectively.

In other instances, executed well status engine 232 may determine the current flow rate or pump rate of each pump is less than the threshold current flow rate or pump rate. In such instances, executed well status engine 232 may determine a fracture stage has initiated or is in progress and the one or more pumps is inactive. Additionally, executed well status engine 232 may generate additional status data indicating the fracture stage has initiated or is in progress and the one or more pumps is inactive. Moreover, executed well status engine 232 may generate a notification and package one or more portions of status data. The one or more portions of status data may identify the well (e.g., an alphanumeric identifier) and indicate that the fracture stage has initiated or is in progress and the one or more pumps is inactive. Further, executed well status engine 232 may cause well status computing system 230 to generate a GUI along with one or more interface elements that present information based on the notification. For instance, the one or more interface elements may present information that the fracture stage has initiated or is in progress and the one or more pumps is inactive. In some instances, executed well status engine 232 may perform operations that store, within the one or more tangible non-transitory memories of well status computing system 230, such as status database 240 and fracturing database 254, the additional status data and fracturing equipment data 204, respectively.

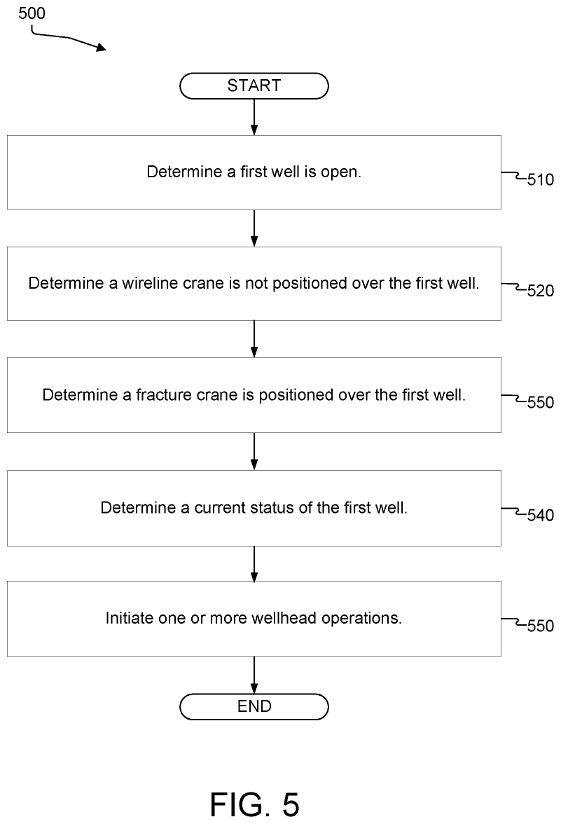

FIG. 5 is a flow chart of an example process 500 for determining a status of a well that is open with a fracture crane positioned over the well and performing one or more wellhead operations associated with the status. In some instances, one or more components of computing environment 200 may perform all or a portion of the steps of example process 500, which include but are not limited to determining a first well is open, determining a wireline crane is not positioned over the first well, determining a fracture crane is positioned over the first well, determining a current status of the first well, and initiating one or more wellhead operations.

Referring to FIG. 5, well status computing system 230 may determine a first well is open (e.g., step 510). In some examples, executed well status engine 232 may obtain, over one or more communications networks, such as communications network 250, wellhead status data 246 from wellhead computing system 240. Additionally, executed well status engine 232 may determine whether a well is closed based on a corresponding portion of wellhead status data 246. For instance, referring to FIG. 1, executed well status engine 232 may determine wellhead 102 is open based on corresponding portions of wellhead status data 246.

Referring to FIG. 5, well status computing system 230 may determine a wireline crane is not positioned over the first well (e.g., 520). In some examples, executed well status engine 232 may obtain, over one or more communications networks, such as communications network 250, wireline crane position data 226 obtained from wireline crane computing system 220. Additionally, executed well status engine 232 may determine a location/position and/or an orientation of a boom of a wireline crane, such as boom 114 of wireline crane 112 of FIG. 1, based on wireline crane position data 226. Moreover, executed well status engine 232 may obtain, over one or more communications networks, such as communications network 250, wellhead status data 246 from wellhead computing system 240. Executed well status engine 232 may determine, for the well, the location of the well/wellhead. Based on the determined location for the well and the determined location/position and/or orientation of a boom of a fracture crane, executed well status engine 232 may determine a position/location and/or orientation of the boom of the wireline crane relative to the well (e.g., whether the boom of the wireline crane is positioned over the well). In some instances, executed well status engine 232 may determine whether a wireline crane is positioned over the first well based on determining the first well is closed.

Referring to FIG. 5, well status computing system 230 may determine a fracture crane is positioned over the first well (e.g., 530). In some examples, executed well status engine 232 may obtain, over one or more communications networks, such as communications network 250, fracture crane position data 216 obtained from fracture crane computing system 210. Additionally, executed well status engine 232 may determine a location/position and/or an orientation of a boom of a fracture crane, such as boom 110 of fracture crane 108 of FIG. 1, based on fracture crane position data 216. Moreover, executed well status engine 232 may obtain, over one or more communications networks, such as communications network 250, wellhead status data 246 from wellhead computing system 240. Executed well status engine 232 may determine, for the well, the location of the well/wellhead. Based on the determined location for the well and the determined location/position and/or orientation of a boom of a fracture crane, executed well status engine 232 may determine the location/position and/or orientation of the boom of the fracture crane relative to the well. In some instances, executed well status engine 232 may determine whether a fracture crane is positioned over the first well based on determining the wireline crane is not positioned over the first well.

Referring to FIG. 5, executed well status engine 2323 may determine a current status of the first well (e.g., step 540). In some examples, executed well status engine 232 may determine whether a fracture stage has initiated or is in progress and whether the one or more pumps of the fracturing equipment is active based on determining the well is open, the fracture crane is positioned over the well and the wireline crane is not positioned over the well. In some instances, executed well status engine 232 may determine the current flow rate or pump rate of each pump is greater than or equal to the threshold current flow rate or pump rate. In such instances, executed well status engine 232 may determine a fracture stage has initiated or is in progress and the one or more pumps of the fracturing equipment is active. Additionally, executed well status engine 232 may generate additional status data indicating the fracture stage has initiated or is in progress and the one or more pumps is active. In other instances, executed well status engine 232 may determine the current flow rate or pump rate of each pump is less than the threshold current flow rate or pump rate. In such instances, executed well status engine 232 may determine a fracture stage has initiated or is in progress and the one or more pumps is inactive. Additionally, executed well status engine 232 may generate additional status data indicating the fracture stage has initiated or is in progress and the one or more pumps is inactive.

Referring to FIG. 5, executed well status engine 2323 may initiate one or more wellhead operations (e.g., step 550). In some examples, executed well status engine 232 may cause a display (e.g., a display of well status computing system 230 or a display of another computing device) to present information included in the status data. In some instances, the status data may identify the well (e.g., an alphanumeric identifier) and indicate that the fracture stage has initiated or is in progress and the one or more pumps is active. Additionally, executed well status engine 232 may cause well status computing system 230 to generate a GUI along with one or more interface elements that present information based on the status data. The one or more interface elements may present information that the fracture stage has initiated or is in progress and the one or more pumps.

In other instances, status data may identify the well (e.g., an alphanumeric identifier) and indicate that the fracture stage has initiated or is in progress and the one or more pumps is inactive. Additionally, executed well status engine 232 may cause well status computing system 230 to generate a GUI along with one or more interface elements that present information based on the status data. The one or more interface elements may present information that the fracture stage has initiated or is in progress and the one or more pumps is inactive.

D. Example Processes for Determining a Status of a Well when the Well is Open with a Wireline Crane Positioned Over the Well.

In some examples, well status computing system 230 may determine a status of a well based on determining the well is open and a wireline crane is positioned over the well. As described herein, executed well status engine 232 may perform the example processes described herein, among other things, to determine the well is open and the wireline crane is positioned over the well. In some instances, executed well status engine 232 may perform example processes described herein, among other things, to additionally determine the fracture crane is not positioned over the well.

Additionally, executed well status engine 232 may determine whether a wireline tool is above or below the surface based on determining the well is open, the wireline crane is positioned over the well, and in some instances, the fracture crane is not positioned over the well. For instance, executed well status engine 232 may obtain, over one or more communications networks, such as communications network 250, wireline equipment data 208 from wireline computing system 206. Additionally, executed well status engine 232 may parse wireline equipment data 208 to determine a vertical position of a wireline tool. Moreover, executed well status engine 232 may compare the vertical position of a wireline tool to a threshold predetermined vertical position value or height. In some instances, the predetermined threshold vertical position value or height (e.g., feet) may represent a ground surface. Further, executed well status engine 232 may determine whether the wireline tool is above or below the surface based on a comparison between vertical position of the wireline tool to the threshold predetermined vertical position value or height.

In some instances, executed well status engine 232 may determine the vertical position of the wireline tool is greater than or equal the threshold predetermined vertical position value or height. In such instances, executed well status engine 232 may determine the cable or the wireline tool is below the surface and a wireline stage has initiated for the well. Additionally, executed well status engine 232 may generate additional status data indicating the cable or the wireline tool is below the surface and the wireline stage or operation has initiated. Based on the status data, executed well status engine 232 may generate a notification and package one or more portions of status data. The one or more portions of status data may identify the well (e.g., an alphanumeric identifier) and indicate that the cable or the wireline tool is below the surface and the wireline stage has initiated. Further, executed well status engine 232 may cause well status computing system 230 to generate a GUI along with one or more interface elements that present information based on the notification. For instance, the one or more interface elements may present information that the cable or the wireline tool is below the surface and the wireline stage has initiated. In some instances, executed well status engine 232 may perform operations that store, within the one or more tangible non-transitory memories of well status computing system 230, such as status database 240 and fracturing database 237, the additional status data and wireline equipment data 208, respectively.

In some instances, executed well status engine 232 may determine the vertical position of the wireline tool is less than the predetermined threshold vertical position value or height. In such instances, executed well status engine 232 may determine the cable or the wireline tool is above the surface. Additionally, executed well status engine 232 may determine whether the wireline tool is powered on or off based on determining the cable or the wireline tool is above the surface. For instance, executed well status engine 232 may obtain, over one or more communications networks, such as communications network 250, wireline equipment data 208 from wireline computing system 206. Additionally, executed well status engine 232 may parse wireline equipment data 208 to determine whether a wireline tool is powered on or off.

In some instances, executed well status engine 232 may determine the wireline tool is powered on based on wireline equipment data 208. In such instances, well status engine 232 may determine the wireline tool is powered on, the wireline tool is above the surface and the wireline stage or operation has initiated. Additionally, executed well status engine 232 may generate additional status data indicating the wireline tool is powered on, the wireline tool is above the surface and the wireline stage or operation has initiated. Additionally, executed well status engine 232 may generate a notification and package one or more portions of status data. The one or more portions of status data may identify the well (e.g., an alphanumeric identifier) and indicate that the wireline tool is powered on, the wireline tool is above the surface, and the wireline stage or operation has initiated. Further, executed well status engine 232 may cause well status computing system 230 to generate a GUI along with one or more interface elements that present information based on the notification. For instance, the one or more interface elements may present information that the wireline tool is powered on, the wireline tool is above the surface, and the wireline stage or operation has initiated. In some instances, executed well status engine 232 may perform operations that store, within the one or more tangible non-transitory memories of well status computing system 230, such as status database 240 and wireline database 238, the additional status data and wireline equipment data 208, respectively.

In other instances, executed well status engine 232 may determines the wireline tool is powered off based on wireline equipment 208. In such instances, executed well status engine may determine whether a pump down pump is active. For instance, executed well status engine 232 may obtain, over one or more communications networks, such as communications network 250, wireline equipment data 208 from wireline computing system 206. Additionally, executed well status engine 232 may parse wireline equipment data 208 to identify, a pump down pump identified in wireline equipment data 208, a current flow rate or pump rate. Moreover, executed well status engine 232 may determine whether the pump down pump is active based on a comparison between the current flow rate or pump rate of the pump down pump and a threshold current flow rate or pump rate.

In some instances, executed well status engine 232 may determine the current flow rate or pump rate of the pump down pump is greater than or equal to the threshold current flow rate or pump rate. In such instances, executed well status engine 232 may determine the pump down pump is active. Additionally, executed well status engine 232 may generate additional status data indicating the pump down pump is active, the wireline tool is above the surface, and the wireline stage or operation has initiated. Moreover, executed well status engine 232 may generate a notification and package one or more portions of status data. The one or more portions of status data may identify the well (e.g., an alphanumeric identifier) and indicate that the pump down pump is active, the wireline tool is above the surface, and the wireline stage or operation has initiated. Further, executed well status engine 232 may cause well status computing system 230 to generate a GUI along with one or more interface elements that present information based on the notification. For instance, the one or more interface elements may present information that the pump down pump is active, the wireline tool is above the surface, and the wireline stage or operation has initiated. In some instances, executed well status engine 232 may perform operations that store, within the one or more tangible non-transitory memories of well status computing system 230, such as status database 240 and wireline database 238, the additional status data and wireline equipment data 208, respectively.

In other instances, executed well status engine 232 may determine the current flow rate or pump rate of the pump down pump is less than the threshold current flow rate or pump rate. In such instances, executed well status engine 232 may determine the pump down pump is inactive. Additionally, executed well status engine 232 may determine whether the winch is active based on determining the pump down pump is inactive. For instance, executed well status engine 232 may obtain, over one or more communications networks, such as communications network 250, wireline equipment data 208 from wireline computing system 206. Additionally, executed well status engine 232 may parse wireline equipment data 208 to determine a drum speed of a winch of the wireline equipment. Moreover, executed well status engine 232 may compare the drum speed of a winch to a predetermined threshold drum speed value (e.g., revolutions per minute). Based on the comparison, executed well status engine 232 may determine whether the winch is active.

In some instances, executed well status engine 232 may determine the drum speed of the winch is greater than a predetermined threshold drum speed value based on the comparison. In such instances, executed well status engine 232 may determine the winch is active (e.g., moving), the wireline tool is above the surface, and the wireline stage or operation has initiated. Additionally, executed well status engine 232 may generate additional status data indicating the winch is active, the wireline tool is above the surface, and the wireline stage or operation has initiated. Moreover, executed well status engine 232 may generate a notification and package one or more portions of status data. The one or more portions of status data may identify the well (e.g., an alphanumeric identifier) and indicate that the winch is active, the wireline tool is above the surface, and the wireline stage or operation has initiated. Further, executed well status engine 232 may cause well status computing system 230 to generate a GUI along with one or more interface elements that present information based on the notification. For instance, the one or more interface elements may present information that the winch is active, the wireline tool is above the surface, and the wireline stage or operation has initiated. In some instances, executed well status engine 232 may perform operations that store, within the one or more tangible non-transitory memories of well status computing system 230, such as status database 240 and wireline database 238, the additional status data and wireline equipment data 208, respectively.

In other instances, executed well status engine 232 determines the drum speed of the winch is less than or equal to a predetermined threshold drum speed value, based on the comparison. In such instances, executed well status engine 232 may determine the winch is inactive (e.g., not moving). Additionally, executed well status engine 232 may determine whether the pressure of the wellhead is equalized based on determining the winch is inactive. For instance, executed well status engine 232 may obtain, over one or more communications networks, such as communications network 250, wireline equipment data 208 from wireline computing system 206. Additionally, executed well status engine 232 may parse wireline equipment data 208 to identify, for a pump down pump identified in wireline equipment data 208, one or more current conditions of each pump down pump, such as the current pressure level of each pump down pump. Moreover, executed well status engine 232 may determine whether the pressure of the wellhead of the well is equalized based on a comparison between the current pressure level of the pump down pump and a threshold pressure level (e.g., psi).

In some instances, executed well status engine 232 may determine the current pressure level of each pump down pump is greater than the threshold pressure level based on wireline equipment data 208. In such instances, executed well status engine 232 may determine the pressure of the wellhead is equalized. Additionally, executed well status engine 232 may generate additional status data indicating the pressure of the wellhead is equalized, the winch is inactive, the wireline tool is above the surface, and the wireline stage or operation has initiated. Moreover, executed well status engine 232 may generate a notification and package one or more portions of status data. The one or more portions of status data may identify the well (e.g., an alphanumeric identifier) and indicate that the pressure of the wellhead is equalized, the winch is inactive, the wireline tool is above the surface, and the wireline stage or operation has initiated. Further, executed well status engine 232 may cause well status computing system 230 to generate a GUI along with one or more interface elements that present information based on the notification. For instance, the one or more interface elements may present information that the pressure of the wellhead is equalized, the winch is inactive, the wireline tool is above the surface, and the wireline stage or operation has initiated. In some instances, executed well status engine 232 may perform operations that store, within the one or more tangible non-transitory memories of well status computing system 230, such as status database 240 and wireline database 238, the additional status data and wireline equipment data 208, respectively.

In other instances, executed well status engine 232 may determine the current pressure level of each pump down pump is equal to or less than the threshold pressure level. In such instances, executed well status engine 232 may determine whether the winch is active (e.g., moving). For instance, executed well status engine 232 may obtain, over one or more communications networks, such as communications network 250, wireline equipment data 208 from wireline computing system 206. Additionally, executed well status engine 232 may parse wireline equipment data 208 to determine a drum speed of a winch. Moreover, executed well status engine 232 may compare the drum speed of a winch to a predetermined threshold drum speed value (e.g., revolutions per minute). Based on the comparison, executed well status engine 232 may determine whether the winch is active.

In some instances, executed well status engine 232 may determine the drum speed of the winch is greater than a predetermined threshold drum speed value. In such instances, executed well status engine 232 may determine the winch is active s (e.g., moving). Additionally, executed well status engine 232 may generate additional status data indicating the winch is active, the pressure of the wellhead is not equalized, the winch is inactive, the wireline tool is above the surface, and the wireline stage or operation has initiated. Additionally, executed well status engine 232 may generate a notification and package one or more portions of status data. The one or more portions of status data may identify the well (e.g., an alphanumeric identifier) and indicate that the winch is active, the pressure of the wellhead is not equalized, the winch is inactive, the wireline tool is above the surface, and the wireline stage or operation has initiated. Further, executed well status engine 232 may cause well status computing system 230 to generate a GUI along with one or more interface elements that present information based on the notification. For instance, the one or more interface elements may present information that the winch is active, the pressure of the wellhead is not equalized, the winch is inactive, the wireline tool is above the surface, and the wireline stage or operation has initiated. In some instances, executed well status engine 232 may perform operations that store, within the one or more tangible non-transitory memories of well status computing system 230, such as status database 240 and wireline database 238, the additional status data and wireline equipment data 208, respectively.

In other instances, executed well status engine 232 may determine the drum speed of the winch is less than or equal to a predetermined threshold drum speed value. In such instances, executed well status engine 232 may determine the winch is inactive (e.g., not moving). Additionally, executed well status engine 232 may generate additional status data indicating the winch is inactive, the pressure of the wellhead is not equalized, the winch is inactive, the wireline tool is above the surface, and the wireline stage or operation has initiated. Additionally, executed well status engine 232 may generate a notification and package one or more portions of status data. The one or more portions of status data may identify the well (e.g., an alphanumeric identifier) and indicate that the winch is inactive, the pressure of the wellhead is not equalized, the winch is inactive, the wireline tool is above the surface, and the wireline stage or operation has initiated. Further, executed well status engine 232 may cause well status computing system 230 to generate a GUI along with one or more interface elements that present information based on the notification. For instance, the one or more interface elements may present information that the winch is inactive, the pressure of the wellhead is not equalized, the winch is inactive, the wireline tool is above the surface, and the wireline stage or operation has initiated. In some instances, executed well status engine 232 may perform operations that store, within the one or more tangible non-transitory memories of well status computing system 230, such as status database 240 and wireline database 238, the additional status data and wireline equipment data 208, respectively.

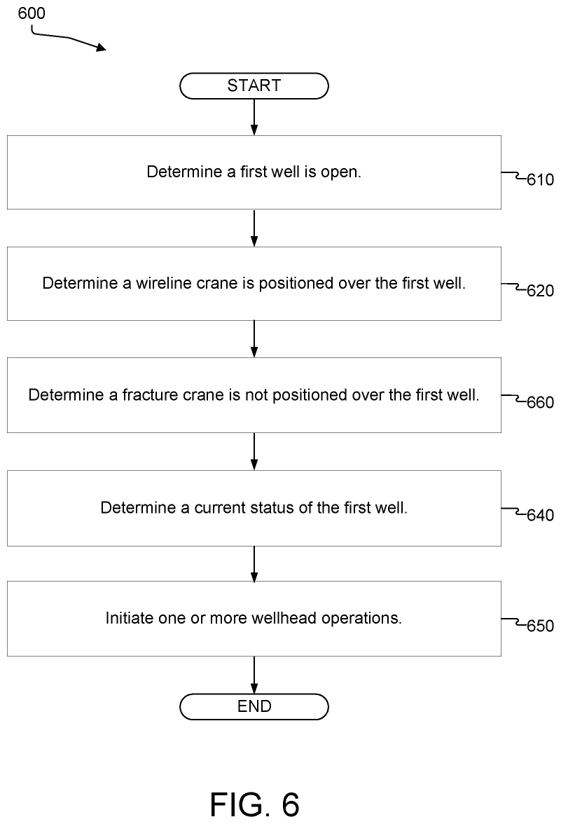

FIG. 6 is a flow chart of an example process 600 for determining a status of a well that is open with a wireline crane positioned over the well and performing one or more wellhead operations associated with the status. In some instances, one or more components of computing environment 200 may perform all or a portion of the steps of example process 600, which include but are not limited to determining a first well is closed, determining a wireline crane is positioned over the first well, determining a fracture crane is not positioned over the first well, determining a current status of the first well, and initiating one or more wellhead operations.

Referring to FIG. 6, well status computing system 230 may determine a first well is open (e.g., step 610). In some examples, executed well status engine 232 may obtain, over one or more communications networks, such as communications network 250, wellhead status data 246 from wellhead computing system 240. Additionally, executed well status engine 232 may determine whether a well is closed based on a corresponding portion of wellhead status data 246. For instance, referring to FIG. 1, executed well status engine 232 may determine wellhead 106 is open based on corresponding portions of wellhead status data 246.

Referring to FIG. 6, well status computing system 230 may determine a wireline crane is positioned over the first well (e.g., 620). In some examples, executed well status engine 232 may obtain, over one or more communications networks, such as communications network 250, wireline crane position data 226 obtained from wireline crane computing system 220. Additionally, executed well status engine 232 may determine a location/position and/or an orientation of a boom of a wireline crane, such as boom 114 of wireline crane 112 of FIG. 1, based on wireline crane position data 226. Moreover, executed well status engine 232 may obtain, over one or more communications networks, such as communications network 250, wellhead status data 246 from wellhead computing system 240. Executed well status engine 232 may determine, for the well, the location of the well/wellhead. Based on the determined location for the well and the determined location/position and/or orientation of a boom of a fracture crane, executed well status engine 232 may determine a position/location and/or orientation of the boom of the wireline crane relative to the well (e.g., whether the boom of the wireline crane is positioned over the well).

Referring to FIG. 6, well status computing system 230 may determine a fracture crane is not positioned over the first well (e.g., step 630). In some examples, executed well status engine 232 may obtain, over one or more communications networks, such as communications network 250, fracture crane position data 216 obtained from fracture crane computing system 210. Additionally, executed well status engine 232 may determine a location/position and/or an orientation of a boom of a fracture crane, such as boom 110 of fracture crane 108 of FIG. 1, based on fracture crane position data 216. Moreover, executed well status engine 232 may obtain, over one or more communications networks, such as communications network 250, wellhead status data 246 from wellhead computing system 240. Executed well status engine 232 may determine, for the well, the location of the well/wellhead. Based on the determined location for the well and the determined location/position and/or orientation of a boom of a fracture crane, executed well status engine 232 may determine the location/position and/or orientation of the boom of the fracture crane relative to the well.

Referring to FIG. 6, executed well status engine 2323 may determine a current status of the first well (e.g., step 640). In some examples, executed well status engine 232 may determine whether a cable of the winch is above or below the surface based on determining the well is open, the wireline crane is positioned over the well, and the fracture crane is not positioned over the well. In some instances, executed well status engine 232 may determine the vertical position of the wireline tool is greater than or equal the threshold predetermined vertical position value or height. In such instances, executed well status engine 232 may determine the cable or the wireline tool is below the surface and a wireline stage has initiated for the well. Additionally, executed well status engine 232 may generate additional status data indicating the cable or the wireline tool is below the surface and the wireline stage or operation has initiated.

In other instances, executed well status engine 232 may determine the vertical position of the wireline tool is less than the predetermined threshold vertical position value or height. In such instances, executed well status engine 232 may determine the cable or the wireline tool is above the surface. Additionally, executed well status engine 232 may determine whether the wireline tool is powered on or off based on determining the cable or the wireline tool is above the surface. In various instances, executed well status engine 232 may determine the wireline tool is powered on based on wireline equipment data 208. In such instances, well status engine 232 may determine the wireline tool is powered on, the wireline tool is above the surface and the wireline stage or operation has initiated. Additionally, executed well status engine 232 may generate additional status data indicating the wireline tool is powered on, the wireline tool is above the surface and the wireline stage or operation has initiated.

In some instances, executed well status engine 232 may determines the wireline tool is powered off based on wireline equipment 208. In such instances, executed well status engine may determine whether a pump down pump is active. In other instances, executed well status engine 232 may determine the current flow rate or pump rate of the pump down pump is greater than or equal to the threshold current flow rate or pump rate. In such instances, executed well status engine 232 may determine the pump down pump is active. Additionally, executed well status engine 232 may generate additional status data indicating the pump down pump is active, the wireline tool is above the surface, and the wireline stage or operation has initiated. Moreover, executed well status engine 232 may generate a notification and package one or more portions of status data.

In various instances, executed well status engine 232 may determine the current flow rate or pump rate of the pump down pump is less than the threshold current flow rate or pump rate. In such instances, executed well status engine 232 may determine the pump down pump is inactive. Additionally, executed well status engine 232 may determine whether the winch is active based on determining the pump down pump is inactive. In some instances, executed well status engine 232 may determine the drum speed of the winch is greater than a predetermined threshold drum speed value based on the comparison. In such instances, executed well status engine 232 may determine the winch is active (e.g., moving), the wireline tool is above the surface, and the wireline stage or operation has initiated. Additionally, executed well status engine 232 may generate additional status data indicating the winch is active, the wireline tool is above the surface, and the wireline stage or operation has initiated.

In other instances, executed well status engine 232 determines the drum speed of the winch is less than or equal to a predetermined threshold drum speed value, based on the comparison. In such instances, executed well status engine 232 may determine the winch is inactive (e.g., not moving). Additionally, executed well status engine 232 may determine whether the pressure of the wellhead is equalized based on determining the winch is inactive. In various instances, executed well status engine 232 may determine the current pressure level of each pump down pump is greater than the threshold pressure level based on wireline equipment data 208. In such instances, executed well status engine 232 may determine the pressure of the wellhead is equalized. Additionally, executed well status engine 232 may generate additional status data indicating the pressure of the wellhead is equalized, the winch is inactive, the wireline tool is above the surface, and the wireline stage or operation has initiated.

In some instances, executed well status engine 232 may determine the current pressure level of each pump down pump is equal to or less than the threshold pressure level. In such instances, executed well status engine 232 may determine whether the winch is active (e.g., moving). In other instances, executed well status engine 232 may determine the drum speed of the winch is greater than a predetermined threshold drum speed value. In such instances, executed well status engine 232 may determine the winch is active (e.g., moving). Additionally, executed well status engine 232 may generate additional status data indicating the winch is active, the pressure of the wellhead is not equalized, the winch is inactive, the wireline tool is above the surface, and the wireline stage or operation has initiated. Additionally, executed well status engine 232 may generate a notification and package one or more portions of status data.

In various instances, executed well status engine 232 may determine the drum speed of the winch is less than or equal to a predetermined threshold drum speed value. In such instances, executed well status engine 232 may determine the winch is inactive (e.g., not moving). Additionally, executed well status engine 232 may generate additional status data indicating the winch is inactive, the pressure of the wellhead is not equalized, the winch is inactive, the wireline tool is above the surface, and the wireline stage or operation has initiated.

Referring to FIG. 6, executed well status engine 2323 may initiate one or more wellhead operations (e.g., step 650). In some examples, executed well status engine 232 may cause a display (e.g., a display of well status computing system 230 or a display of another computing device) to present information included in the status data. In some instances, the status data may identify the well (e.g., an alphanumeric identifier) and indicate that the cable or the wireline tool is below the surface and the wireline stage has initiated. Additionally, executed well status engine 232 may cause well status computing system 230 to generate a GUI along with one or more interface elements that present information based on the status data. The one or more interface elements may present information that the cable or the wireline tool is below the surface and the wireline stage has initiated.

In other instances, the status data may identify the well (e.g., an alphanumeric identifier) and indicate that the wireline tool is powered on, the wireline tool is above the surface, and the wireline stage or operation has initiated. Further, executed well status engine 232 may cause well status computing system 230 to generate a GUI along with one or more interface elements that present information based on the status data. The one or more interface elements may present information that the wireline tool is powered on, the wireline tool is above the surface, and the wireline stage or operation has initiated.

In various instances status data may identify the well (e.g., an alphanumeric identifier) and indicate that the pump down pump is active, the wireline tool is above the surface, and the wireline stage or operation has initiated. Additionally, executed well status engine 232 may cause well status computing system 230 to generate a GUI along with one or more interface elements that present information based on the status data. The one or more interface elements may present information that the pump down pump is active, the wireline tool is above the surface, and the wireline stage or operation has initiated.

In some instances, status data may identify the well (e.g., an alphanumeric identifier) and indicate that the winch is active, the wireline tool is above the surface, and the wireline stage or operation has initiated. Additionally, executed well status engine 232 may cause well status computing system 230 to generate a GUI along with one or more interface elements that present information based on the notification. The one or more interface elements may present information that the winch is active, the wireline tool is above the surface, and the wireline stage or operation has initiated.

In other instances, status data may identify the well (e.g., an alphanumeric identifier) and indicate that the pressure of the wellhead is equalized, the winch is inactive, the wireline tool is above the surface, and the wireline stage or operation has initiated. Additionally, executed well status engine 232 may cause well status computing system 230 to generate a GUI along with one or more interface elements that present information based on the notification. The one or more interface elements may present information that the pressure of the wellhead is equalized, the winch is inactive, the wireline tool is above the surface, and the wireline stage or operation has initiated.

In various instances, status data may identify the well (e.g., an alphanumeric identifier) and indicate that the winch is active, the pressure of the wellhead is not equalized, the winch is inactive, the wireline tool is above the surface, and the wireline stage or operation has initiated. Additionally, executed well status engine 232 may cause well status computing system 230 to generate a GUI along with one or more interface elements that present information based on the notification. The one or more interface elements may present information that the winch is active, the pressure of the wellhead is not equalized, the winch is inactive, the wireline tool is above the surface, and the wireline stage or operation has initiated.

In some instances, the status data may identify the well (e.g., an alphanumeric identifier) and indicate that the winch is inactive, the pressure of the wellhead is not equalized, the winch is inactive, the wireline tool is above the surface, and the wireline stage or operation has initiated. Additionally, executed well status engine 232 may cause well status computing system 230 to generate a GUI along with one or more interface elements that present information based on the notification. The one or more interface elements may present information that the winch is inactive, the pressure of the wellhead is not equalized, the winch is inactive, the wireline tool is above the surface, and the wireline stage or operation has initiated.

E. Example Processes for Determining a Status of a Well when the Well is Closed with Neither Wireline Crane or Fracture Crane Positioned Over the Well.

In some examples, well status computing system 230 may determine a status of a well based on determining the well is closed and neither wireline crane or fracture crane is positioned over the well. In such instances, executed well status engine 232 may perform the example processes described herein, among other things, to determine the well is closed and neither the wireline crane and fracture crane is positioned over the well. Additionally, executed well status engine 232 may determine whether the set of plug-and-perf operations are complete for the well.

For instance, executed well status engine 232 may obtain, over one or more communications networks, such as communications network 250, fracturing job data 205 from fracturing computing system 202. Additionally, executed well status engine 232 may obtain, over one or more communications networks, such as communications network 250, wireline job data 209 from wireline computing system 206. Moreover, executed well status engine 232 may determine, for a well, whether all of the fracture stages of a set of plug-and-perf operations of the well are completed based on fracturing job data 205. Further, executed well status engine 232 may determine, for a well, whether all of the wireline stages of the set of plug-and-perf operations of the well are completed based on wireline job data 209. Based on whether all of the fracture stages and all of the wireline stages of the set of plug-and-perf operations of the well are determined completed, executed well status engine 232 may determine whether the set of plug-and-perf operations are complete for the well.

In some instances, executed well status engine 232 may determine all of the fracture stages and all of the wireline stages of the set of plug-and-perf operations of the well are completed based on fracturing job data 205 and wireline job data 209, respectively. In such instances, executed well status engine 232 may determine the set of plug-and-perf operations of the well are complete. Additionally, executed well status engine 232 may end the process.

In other instances, executed well status engine 232 determines not all of the fracture stages and/or not all of the wireline stages of the set of plug-and-perf operations of the well are completed based on fracturing job data 205 and wireline job data 209, respectively. In such instances, executed well status engine 232 may determine the set of plug-and-perf operations of the well is not complete. Additionally, executed well status engine 232 may determine the well is closed and the wireline stages/operations or the fracture stages/operations is not currently being implemented on the well. Moreover, executed well status engine 232 may generate additional status data indicating well is closed and the wireline stages/operations or the fracture stages/operations is not currently being implemented on the well. Further, executed well status engine 232 may generate a notification and package one or more portions of status data. The one or more portions of status data may identify the well (e.g., an alphanumeric identifier) and indicate that the well is closed and the wireline stages/operations or the fracture stages/operations is not currently being implemented on the well. Additionally, executed well status engine 232 may cause well status computing system 230 to generate a GUI along with one or more interface elements that present information based on the notification. For instance, the one or more interface elements may present information that the well is closed and the wireline stages/operations or the fracture stages/operations is not currently being implemented on the well. In some instances, executed well status engine 232 may perform operations that store, within the one or more tangible non-transitory memories of well status computing system 230, such as status database 240 and wireline database 238, the additional status data and wireline equipment data 208, respectively.

### F. Example Processes for Additional Operations Based on the Status of the Well.

Further, well status computing system 230 may perform any of the example processes described herein, to among other things, perform one or more additional operations based on status data. In some examples, status data may be associated with a well that is open and the wireline crane is positioned over the well. In some instances, status data may further indicate a wireline tool is powered on, the wireline tool is above the surface, and the wireline stage or operation has initiated. In such instances, executed well status engine 232 may generate a wireline equipment message. The wireline equipment message include an identifier of the wireline tool (e.g., an alphanumeric identifier associated with the wireline tool) and may include instructions to turn the power of the wireline tool off. Additionally, executed well status engine 232 may transmit, over the one or more communications networks, such as communications network 250, the wireline equipment message to wireline computing system 206. Wireline computing system 206 may parse the wireline equipment message and identify the wireline tool based on the identifier of the wireline tool included in the wireline equipment message. Moreover, wireline computing system 206 may cause the wireline tool identified in the wireline equipment message to turn the power off based on the instructions included in the wireline equipment message.

In other instances, status data may further indicate a pump down pump is active, the wireline tool is above the surface, and the wireline stage or operation has initiated. In such instances, executed well status engine 232 may generate a wireline equipment message. The wireline equipment message may include an identifier of the pump down pump (e.g., an alphanumeric identifier associated with the pump down pump) and may include instructions to turn the power of the pump down pump off. Additionally, executed well status engine 232 may transmit, over the one or more communications networks, such as communications network 250, the wireline equipment message to wireline computing system 206. Wireline computing system 206 may parse the wireline equipment message and identify the pump down pump based on the identifier of the pump down pump. Moreover, wireline computing system 206 may cause the pump down pump identified in the wireline equipment message to turn the power off based on the instructions included in the wireline equipment message.

In various instances, status data may further indicate a winch is active, the wireline tool is above the surface, and the wireline stage or operation have initiated. In such instances, executed well status engine 232 may generate a wellhead message. The wellhead message may include an identifier of the well (e.g., an alphanumeric identifier associated with the well) and instructions to lock out controls to the wellhead of the well. Additionally, executed well status engine 232 may transmit, over the one or more communications networks, such as communications network 250, the wellhead message to wellhead computing system 240. Wellhead computing system 240 may parse the wellhead message and identify the well and corresponding wellhead based on the identifier of the well included in the wellhead message. Moreover, wellhead computing system may cause the controls to the identified wellhead to be locked out and prevent an operator to use the controls. For instance, based on the wellhead message, processor 244 of wellhead computing system 240 may cause a graphical user interface (GUI) to disable functionality of one or more interface elements that may enable an operator to open or close the wellhead of the well. That way, the operator may not close or open the wellhead while the controls are locked out. In some instances, the GUI may also include additional interface elements that may each control the wellheads of other wells. In such instances, the additional interface elements may not be locked out, while the one or more interface elements controlling the identified wellhead of the well may be locked out.

In some instances, status data may further indicate a winch is active, the wireline tool is above the surface, and the wireline stage or operation has initiated. In such instances, executed well status engine 232 may generate a wellhead message. The wellhead message may include an identifier of the well (e.g., an alphanumeric identifier associated with the well) and instructions close the well. Additionally, executed well status engine 232 may transmit, over the one or more communications networks, such as communications network 250, the wellhead message to wellhead computing system 240. Wellhead computing system 240 may parse the wellhead message and identify the well and corresponding wellhead based on the identifier of the well included in the wellhead message. Moreover, wellhead computing system 240 may cause the identified wellhead to close based on the instructions included in the wellhead message.

### G. Example Hardware and Software Implementations

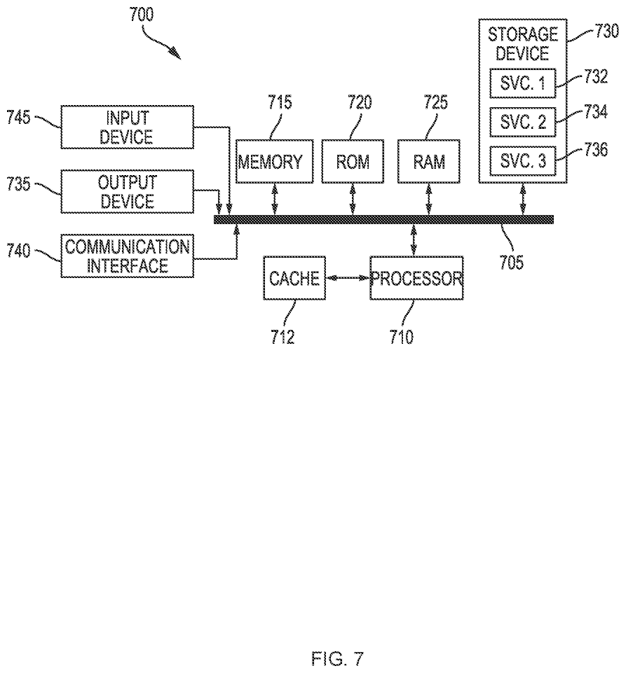

FIG. 7 illustrates an example computing device architecture 700 which can be employed to perform various steps, methods, and techniques disclosed herein. Specifically, the computing device architecture can be integrated with the electromagnetic imager tools described herein. Further, the computing device can be configured to implement the techniques of controlling borehole image blending through machine learning described herein.

As noted above, FIG. 7 illustrates an example computing device architecture 700 of a computing device which can implement the various technologies and techniques described herein. The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics. The processor 710 can include any general purpose processor and a hardware or software service, such as service 1 732, service 2 734, and service 3 736 stored in storage device 730, configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art, such as a display, projector, television, speaker device, etc. In some instances, multimodal computing devices can enable a user to provide multiple types of input to communicate with the computing device architecture 700. The communications interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include services 732, 734, 736 for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the disclosure include:

Aspect 1. A computing system comprising: a communications interface; a memory storing instructions; and at least one processor coupled to the communications interface and to the memory, the at least one processor being configured to execute the instructions to perform operations including: determine a first well is closed based on wellhead status data; determine a wireline crane is not positioned over the first well based on wireline crane positioning data; determine a fracture crane is positioned over the first well based on fracture crane positioning data; determine a current status of the first well based on a portion of job data associated with the first well, and fracturing equipment data; and initiate one or more wellhead operations based on the current status of the first well.

Aspect 2. The computing system of Aspect 1, wherein to determine the current status of the first well, the at least one processor is further configured to: determine a set of wireline operations have not been completed based on job data associated with the first well; and based on determining the set of wireline operations have not been completed, determine the first well is not ready for fracturing operations, wherein the current status is based in part on determining that the first well is not ready for fracturing operations.

Aspect 3. The computing system of Aspects 1 or 2, wherein to determine the current status of the first well, the at least one processor is further configured to: determine a set of wireline operations have been completed based on job data associated with the first well; determine a pressure of a pump of one or more fracturing equipment is less than a threshold pressure based on the fracturing equipment data and determining the set of wireline operations have been completed; and determine the fracture crane is positioned over the first well and the first well is not equalized based on determining the pressure of the pump is less than a threshold pressure, wherein the current status is based in part on determining the fracture crane is positioned over the first well and the first well is not equalized.

Aspect 4. The computing system of Aspects 1-3, wherein to determine the current status of the first well, the at least one processor is further configured to: determine a set of wireline operations have been completed based on job data associated with the first well; determine a pressure of a pump of one or more fracturing equipment is greater than a threshold pressure, based on determining the set of wireline operations have been completed and the fracturing equipment data; and determine the fracture crane is positioned over the first well and the first well is equalized, based on determining the pressure of the pump is greater than a threshold pressure, wherein the current status is based in part on determining the fracture crane is positioned over the first well and the first well is equalized.

Aspect 5. The computing system of claims 1-4, wherein the at least one processor is configured to execute to further perform operations that include: obtain the fracturing equipment data, the fracturing equipment data characterizes one or more attributes of each of one or more fracturing equipment; and obtain the job data of one or more wells including the first well, the job data including, for each of the one or more wells, wireline operations information characterizing a status of each of one or more wireline operations and fracturing operations information characterizing a status of each of one or more fracturing operations.

Aspect 6. The computing system of Aspect 5, wherein the fracturing equipment data includes flow rate information and flow rate information.

Aspect 7. The computing system of Aspect 5, wherein the job data further includes location information of each of the one or more wells.

Aspect 8. The computing system of Aspects 1-7, wherein to determine the wireline crane is not positioned over the first well, the at least one processor is further configured to: determine the wireline crane is positioned over the first well for less than a predetermined time interval based on the wireline crane positioning data.

Aspect 9. The computing system of Aspects 1-8, wherein to determine the fracture crane is positioned over the first well, the at least one processor is further configured to: determine the fracture crane is positioned over the first well for a predetermined time interval based on the fracture crane positioning data.

Aspect 10. The computing system of Aspects 1-9, wherein the at least one processor is configured to execute to further perform operations that include: obtain the wireline crane position data, the wireline crane position data including location information of the wireline crane and orientation information of the wireline crane.

Aspect 11. The computing system of Aspect 10, wherein the orientation information of the wireline crane is based on sensor data generated by a magnetometer of the wireline crane.

Aspect 12. The computing system of claim Aspect 10, wherein the location information of the wireline crane is based on location data generated by a global positioning system device (GPS) device of the wireline crane.

Aspect 13. The computing system of Aspects 1-12, wherein the at least one processor is configured to execute to further perform operations that include: obtain the fracture crane positioning data, the fracture crane positioning data including location information of the fracture crane and orientation information of the fracture crane.

Aspect 14. The computing system of Aspect 13, wherein the orientation information of the fracture crane is based on sensor data generated by a magnetometer of the fracture crane.

Aspect 15. The computing system of Aspect 13, wherein the location information of the fracture crane is based on location data generated by a global positioning system device (GPS) device of the fracture crane.

Aspect 16. The computing system of Aspects 1-15, wherein the at least one processor is configured to execute to further perform operations that include: obtain the wellhead status data, the wellhead status data being associated with one or more wells including the first well.

Aspect 17. The computing system of Aspect 16, wherein the wellhead status data is generated by one or more sensors of the one or more wells.

Aspect 18. The computing system of Aspect 17, wherein the one or more sensors includes a hydraulic actuated wellhead sensor.

Aspect 19. A computer-implemented method comprising: determining a first well is closed based on wellhead status data; determining a wireline crane is not positioned over the first well based on wireline crane positioning data; determining a fracture crane is positioned over the first well based on fracture crane positioning data; determining a current status of the first well based on a portion of job data associated with the first well, and fracturing equipment data; and initiating one or more wellhead operations based on the current status of the first well.

Aspect 20. A tangible, non-transitory computer readable medium storing instructions that, when executed by at least one processor, cause the at least one processor to perform operations comprising: determining a first well is closed based on wellhead status data; determining a wireline crane is not positioned over the first well based on wireline crane positioning data; determining a fracture crane is positioned over the first well based on fracture crane positioning data; determining a current status of the first well based on a portion of job data associated with the first well, and fracturing equipment data; and initiating one or more wellhead operations based on the current status of the first well.

Aspect 21. A computing system comprising: a communications interface; a memory storing instructions; and at least one processor coupled to the communications interface and to the memory, the at least one processor being configured to execute the instructions to perform operations including: determine a first well is closed based on wellhead status data; determine wireline crane is positioned over the first well based on wireline crane positioning data; determine a current status of the first well based on a portion of job data associated with the first well, and wireline equipment data; and initiate one or more wellhead operations based on the current status of the first well.

Aspect 22. The computing system of Aspect 21, wherein to determine the current status of the first well, the at least one processor is further configured to: determine a set of fracture operations have not been completed based on the portion of the job data associated with the first well; and determine the first well is not ready for wireline operations, based on determining the set of fracture operations have not been completed, wherein the current status is based in part on determining the first well is not ready for wireline operations.

Aspect 23. The computing system of Aspects 21 or 22, wherein to determine the current status of the first well, the at least one processor is further configured to: determine a set of fracture operations have been completed based on the portion of the job data associated with the first well; determining a surface tension of a wireline is less than a threshold surface tension, based on the wireline equipment data and determining the set of fracture operations have been completed; and determine a set of wireline operations have been initiated for the first well, based on determining the surface tension of the wireline is less than the threshold surface tension, wherein the current status is based in part on determining the set of wireline operations have been initiated for the first well.

Aspect 24. The computing system of Aspect 21-23, wherein to determine the current status of the first well, the at least one processor is further configured to: determine a set of fracture operations have been completed based on the portion of the job data associated with the first well; determine a surface tension of a wireline is greater than or equal to a threshold surface tension, based on the wireline equipment data and determining the set of fracture operations have been completed; determine a pressure of a pump of one or more wireline equipment is less than a threshold pressure based on the wireline equipment data and determining the surface tension of the wireline is greater than or equal to the threshold surface tension; and determine the wireline crane is positioned over the first well and a pressure of the first well is not equalized, based on determining the pressure of the pump is less than the threshold pressure, wherein the current status is based in part on determining the wireline crane is positioned over the first well and the pressure of the first well is not equalized.

Aspect 25. The computing system of Aspects 21-24, wherein to determine the current status of the first well, the at least one processor is further configured to: determine a set of fracture operations have been completed based on the portion of the job data associated with the first well; determine a surface tension of a wireline is greater than or equal to a threshold surface tension, based on the wireline equipment data, based on the wireline equipment data and determining the set of fracture operations have been completed; determine a pressure of a pump of one or more wireline equipment is greater than a threshold pressure based on the wireline equipment data and determining the surface tension of the wireline is greater than or equal to the threshold surface tension; and determine the wireline crane is positioned over the first well and a pressure of the first well is equalized, based on determining the pressure of the pump is greater than the threshold pressure, wherein the current status is based in part on determining the wireline crane is positioned over the first well and the pressure of the first well is equalized.

Aspect 26. The computing system of Aspects 21-25, wherein the at least one processor is configured to execute to further perform operations that include: obtain the wireline equipment data, the wireline equipment data characterizes one or more attributes of each of one or more wireline equipment; and obtain the job data of one or more wells including the first well, the job data including, for each of the one or more wells, wireline operations information characterizing a status of each of one or more wireline operations and fracturing operations information characterizing a status of each of one or more fracturing operations.

Aspect 27. The computing system of Aspect 26, wherein the wireline equipment data includes depth information, tension information, drum information, flow rate information and tool information.

Aspect 28. The computing system of Aspect 6, wherein the job data further includes location information of each of the one or more wells.

Aspect 29. The computing system of Aspects 21-28, wherein to determine the wireline crane is positioned over the first well, the at least one processor is further configured to: determine the wireline crane is positioned over the first well for more than a predetermined time interval based on the wireline crane positioning data.

Aspect 30. The computing system of Aspects 21-29, wherein the at least one processor is configured to execute to further perform operations that include: obtain the wireline crane positioning data, the wireline crane positioning data including location information of the wireline crane and orientation information of the wireline crane.

Aspect 31. The computing system of Aspect 30, wherein the orientation information of the wireline crane is based on sensor data generated by a magnetometer of the wireline crane.

Aspect 32. The computing system of Aspect 30, wherein the location information of the wireline crane is based on location data generated by a global positioning system device (GPS) device of the wireline crane.

Aspect 33. The computing system of Aspects 21-32, wherein the at least one processor is configured to execute to further perform operations that include: obtain the wellhead status data, the wellhead status data being associated with one or more wells including the first well.

Aspect 34. The computing system of Aspect 33, wherein the wellhead status data is generated by one or more sensors of the one or more wells.

Aspect 35. The computing system of Aspect 34, wherein the one or more sensors includes a hydraulic actuated wellhead sensor.

Aspect 36. The computing system of Aspects 33-35, wherein the wellhead status data indicates whether a corresponding wellhead is open or closed.

Aspect 37. A computer-implemented method comprising: determining a first well is closed based on wellhead status data; determining wireline crane is positioned over the first well based on wireline crane positioning data; determining a current status of the first well based on a portion of job data associated with the first well, and wireline equipment data; and initiating one or more wellhead operations based on the current status of the first well.

Aspect 38. The computer-implemented method of Aspect 37, wherein determining the current status of the first well includes: determining a set of fracture operations have not been completed; and based on determining the set of fracture operations have not been completed, determining the first well is not ready for wireline operations, wherein the current status is based in part on determining the first well is not ready for wireline operations.

Aspect 39. The computer-implemented method of Aspect 37, wherein determining the current status of the first well includes: determining a set of fracture operations have been completed; based on determining the set of fracture operations have been completed, determining whether a surface tension of a wireline is greater than a threshold surface tension, based on the wireline equipment data, wherein current status is based in part on determining whether the surface tension of the wireline is greater than a threshold surface tension.

Aspect 40. A tangible, non-transitory computer readable medium storing instructions that, when executed by at least one processor, cause the at least one processor to perform operations comprising: determining a first well is closed based on wellhead status data; determining wireline crane is positioned over the first well based on wireline crane positioning data; determining a current status of the first well based on a portion of job data associated with the first well, and wireline equipment data; and initiating one or more wellhead operations based on the current status of the first well.

Aspect 41. A computing system comprising: a communications interface; a memory storing instructions; and at least one processor coupled to the communications interface and to the memory, the at least one processor being configured to execute the instructions to perform operations including: determine a first well is open based on wellhead status data; determine a fracture crane is positioned over the first well based on fracture crane positioning data; determine a current status of the first well based on a portion of job data associated with the first well, and fracturing equipment data; and initiate one or more wellhead operations based on the current status of the first well.

Aspect 42. The computing system of Aspect 41, wherein to determine the current status of the first well, the at least one processor is further configured to: determine a flow rate of a pump of one or more fracturing equipment is greater than a threshold flow rate based on the fracturing equipment data; and determine one or more fracture operations has initiated for the first well and the pump of the one or more fracturing equipment is active, based on determining the flow rate of the pump is greater than a threshold flow rate, wherein the current status is based in part on determining the one or more fracture operations has initiated for the first well and the pump of the one or more fracturing equipment is active.

Aspect 43. The computing system of Aspects 41 or 42, wherein to determine the current status of the first well, the at least one processor is further configured to: determine a flow rate of a pump of one or more fracturing equipment is less than a threshold flow rate based on the fracturing equipment data; and determine one or more fracture operations has initiated for the first well and the pump of the one or more fracturing equipment is inactive, based on determining the flow rate of the pump is less than a threshold flow rate, wherein the current status is based in part on determining the one or more fracture operations has initiated for the first well and the pump of the one or more fracturing equipment is inactive.

Aspect 44. The computing system of Aspects 41-44, wherein the at least one processor is configured to execute to further perform operations that include: obtain the fracturing equipment data, the fracturing equipment data characterizes one or more attributes of each of one or more fracturing equipment; and obtain the job data of one or more wells including the first well, the job data including, for each of the one or more wells, wireline operations information characterizing a status of each of one or more wireline operations and fracture operations information characterizing a status of each of one or more fracture operations.

Aspect 45. The computing system of Aspect 44, wherein the fracturing equipment data includes flow rate information and flow rate information.

Aspect 46. The computing system of Aspect 44, wherein the job data further includes location information of each of the one or more wells.

Aspect 47. The computing system of Aspects 41-46, wherein to determine the fracture crane is positioned over the first well, the at least one processor is further configured to: determine the fracture crane is positioned over the first well for a predetermined time interval based on the fracture crane positioning data.

Aspect 48. The computing system of Aspects 41-47, wherein the at least one processor is configured to execute to further perform operations that include: obtain the fracture crane positioning data, the fracture crane positioning data including location information of the fracture crane and orientation information of the fracture crane.

Aspect 49. The computing system of Aspect 48, wherein the orientation information of the fracture crane is based on sensor data generated by a magnetometer of the fracture crane.

Aspect 50. The computing system of Aspect 48, wherein the location information of the fracture crane is based on location data generated by a global positioning system device (GPS) device of the fracture crane.

Aspect 51. The computing system of Aspects 41-50, wherein the at least one processor is configured to execute to further perform operations that include: obtain the wellhead status data, the wellhead status data being associated with one or more wells including the first well.

Aspect 52. The computing system of Aspects 41-51, wherein the wellhead status data is generated by one or more sensors of the one or more wells.

Aspect 53. The computing system of Aspect 52, wherein the one or more sensors includes a hydraulic actuated wellhead sensor.

Aspect 54. The computing system of Aspects 51-53, wherein the wellhead status data indicates whether a corresponding wellhead is open or closed.

Aspect 55. A computer-implemented method comprising: determining a first well is open based on wellhead status data; determining a fracture crane is positioned over the first well based on fracture crane positioning data; determining a current status of the first well based on a portion of job data associated with the first well, and fracturing equipment data; and initiating one or more wellhead operations based on the current status of the first well.

Aspect 56. The computer-implemented method of Aspect 55, wherein determining the current status of the first well includes: determining a flow rate of a pump of one or more fracturing equipment is greater than a threshold flow rate based on the fracturing equipment data; and determining one or more fracture operations has initiated for the first well and the pump of the one or more fracturing equipment is active, based on determining the flow rate of the pump is greater than a threshold flow rate, wherein the current status is based in part on determining the one or more fracture operations has initiated for the first well and the pump of the one or more fracturing equipment is active.

Aspect 57. The computer-implemented method of Aspects 55 or 56, wherein determining the current status of the first well includes: determining a flow rate of a pump of one or more fracturing equipment is less than a threshold flow rate based on the fracturing equipment data; and determining one or more fracture operations has initiated for the first well and the pump of the one or more fracturing equipment is inactive, based on determining the flow rate of the pump is less than a threshold flow rate, wherein the current status is based in part on determining the one or more fracture operations has initiated for the first well and the pump of the one or more fracturing equipment is inactive.

Aspect 58. A tangible, non-transitory computer readable medium storing instructions that, when executed by at least one processor, cause the at least one processor to perform operations comprising: determining a first well is open based on wellhead status data; determining a fracture crane is positioned over the first well based on fracture crane positioning data; determining a current status of the first well based on a portion of job data associated with the first well and fracturing equipment data; and initiating one or more wellhead operations based on the current status of the first well.

Aspect 59. The tangible, non-transitory computer readable medium of Aspect 58, wherein determining the current status of the first well includes: determining a flow rate of a pump of one or more fracturing equipment is greater than a threshold flow rate based on the fracturing equipment data; and determining one or more fracture operations has initiated for the first well and the pump of the one or more fracturing equipment is active, based on determining the flow rate of the pump is greater than a threshold flow rate, wherein the current status is based in part on determining the one or more fracture operations has initiated for the first well and the pump of the one or more fracturing equipment is active.

Aspect 60. The tangible, non-transitory computer readable medium of Aspects 58 or 59, wherein determining the current status of the first well includes: determining a flow rate of a pump of one or more fracturing equipment is less than a threshold flow rate based on the fracturing equipment data; and determining one or more fracture operations has initiated for the first well and the pump of the one or more fracturing equipment is inactive, based on determining the flow rate of the pump is less than a threshold flow rate, wherein the current status is based in part on determining the one or more fracture operations has initiated for the first well and the pump of the one or more fracturing equipment is inactive.

Aspect 61. A computing system comprising: a communications interface; a memory storing instructions; and at least one processor coupled to the communications interface and to the memory, the at least one processor being configured to execute the instructions to perform operations including: determine a first well is open based on wellhead status data; determine a fracture crane is positioned over the first well based on fracture crane positioning data; determine a current status of the first well based on a portion of job data associated with the first well, and fracturing equipment data; and initiate one or more wellhead operations based on the current status of the first well.

Aspect 62. The computing system of Aspect 61, wherein to determine the current status of the first well, the at least one processor is further configured to: determine a flow rate of a pump of one or more fracturing equipment is greater than a threshold flow rate based on the fracturing equipment data; and determine one or more fracture operations has initiated for the first well and the pump of the one or more fracturing equipment is active, based on determining the flow rate of the pump is greater than a threshold flow rate, wherein the current status is based in part on determining the one or more fracture operations has initiated for the first well and the pump of the one or more fracturing equipment is active.

Aspect 63. The computing system of Aspects 61 or 62, wherein to determine the current status of the first well, the at least one processor is further configured to: determine a flow rate of a pump of one or more fracturing equipment is less than a threshold flow rate based on the fracturing equipment data; and determine one or more fracture operations has initiated for the first well and the pump of the one or more fracturing equipment is inactive, based on determining the flow rate of the pump is less than a threshold flow rate, wherein the current status is based in part on determining the one or more fracture operations has initiated for the first well and the pump of the one or more fracturing equipment is inactive.

Aspect 64. The computing system of Aspects 61-63, wherein the at least one processor is configured to execute to further perform operations that include: obtain the fracturing equipment data, the fracturing equipment data characterizes one or more attributes of each of one or more fracturing equipment; and obtain the job data of one or more wells including the first well, the job data including, for each of the one or more wells, wireline operations information characterizing a status of each of one or more wireline operations and fracture operations information characterizing a status of each of one or more fracture operations.

Aspect 65. The computing system of Aspect 64, wherein the fracturing equipment data includes flow rate information and flow rate information.

Aspect 66. The computing system of Aspect 64, wherein the job data further includes location information of each of the one or more wells.

Aspect 67. The computing system of Aspects 61-66, wherein to determine the fracture crane is positioned over the first well, the at least one processor is further configured to: determine the fracture crane is positioned over the first well for a predetermined time interval based on the fracture crane positioning data.

Aspect 68. The computing system of Aspects 61-67, wherein the at least one processor is configured to execute to further perform operations that include: obtain the fracture crane positioning data, the fracture crane positioning data including location information of the fracture crane and orientation information of the fracture crane.

Aspect 69. The computing system of Aspect 68, wherein the orientation information of the fracture crane is based on sensor data generated by a magnetometer of the fracture crane.

Aspect 70. The computing system of Aspect 68, wherein the location information of the fracture crane is based on location data generated by a global positioning system device (GPS) device of the fracture crane.

Aspect 71. The computing system of Aspects 61-70, wherein the at least one processor is configured to execute to further perform operations that include: obtain the wellhead status data, the wellhead status data being associated with one or more wells including the first well.

Aspect 72. The computing system of Aspect 71, wherein the wellhead status data is generated by one or more sensors of the one or more wells.

Aspect 73. The computing system of Aspect 72, wherein the one or more sensors includes a hydraulic actuated wellhead sensor.

Aspect 74. The computing system of Aspects 71-73, wherein the wellhead status data indicates whether a corresponding wellhead is open or closed.

Aspect 75. A computer-implemented method comprising: determining a first well is open based on wellhead status data; determining a fracture crane is positioned over the first well based on fracture crane positioning data; determining a current status of the first well based on a portion of job data associated with the first well, and fracturing equipment data; and initiating one or more wellhead operations based on the current status of the first well.

Aspect 76. The computer-implemented method of Aspect 75, wherein determining the current status of the first well includes: determining a flow rate of a pump of one or more fracturing equipment is greater than a threshold flow rate based on the fracturing equipment data; and determining one or more fracture operations has initiated for the first well and the pump of the one or more fracturing equipment is active, based on determining the flow rate of the pump is greater than a threshold flow rate, wherein the current status is based in part on determining the one or more fracture operations has initiated for the first well and the pump of the one or more fracturing equipment is active.

Aspect 77. The computer-implemented method of Aspects 75 or 76, wherein determining the current status of the first well includes: determining a flow rate of a pump of one or more fracturing equipment is less than a threshold flow rate based on the fracturing equipment data; and determining one or more fracture operations has initiated for the first well and the pump of the one or more fracturing equipment is inactive, based on determining the flow rate of the pump is less than a threshold flow rate, wherein the current status is based in part on determining the one or more fracture operations has initiated for the first well and the pump of the one or more fracturing equipment is inactive.

Aspect 78. A tangible, non-transitory computer readable medium storing instructions that, when executed by at least one processor, cause the at least one processor to perform operations comprising: determining a first well is open based on wellhead status data; determining a fracture crane is positioned over the first well based on fracture crane positioning data; determining a current status of the first well based on a portion of job data associated with the first well and fracturing equipment data; and initiating one or more wellhead operations based on the current status of the first well.

Aspect 79. The tangible, non-transitory computer readable medium of Aspect 78, wherein determining the current status of the first well includes: determining a flow rate of a pump of one or more fracturing equipment is greater than a threshold flow rate based on the fracturing equipment data; and determining one or more fracture operations has initiated for the first well and the pump of the one or more fracturing equipment is active, based on determining the flow rate of the pump is greater than a threshold flow rate, wherein the current status is based in part on determining the one or more fracture operations has initiated for the first well and the pump of the one or more fracturing equipment is active.

Aspect 80. The tangible, non-transitory computer readable medium of Aspects or 78 or 79, wherein determining the current status of the first well includes: determining a flow rate of a pump of one or more fracturing equipment is less than a threshold flow rate based on the fracturing equipment data; and determining one or more fracture operations has initiated for the first well and the pump of the one or more fracturing equipment is inactive, based on determining the flow rate of the pump is less than a threshold flow rate, wherein the current status is based in part on determining the one or more fracture operations has initiated for the first well and the pump of the one or more fracturing equipment is inactive.

1-20. (canceled)

21. A computing system comprising:
a communications interface;
a memory storing instructions; and
at least one processor coupled to the communications interface and to the memory, the at least one processor being configured to execute the instructions to perform operations including:
determine a first well is open based on wellhead status data;
determine a wireline crane is positioned over the first well based on wireline crane positioning data;
determine a current status of the first well based on a portion of job data associated with the first well, and wireline equipment data; and
initiate one or more wellhead operations based on the current status of the first well.

22. The computing system of claim 21, wherein to determine the current status of the first well, the at least one processor is further configured to:
determine a wireline of the wireline crane is greater than a threshold depth based on the wireline equipment data; and
determine one or more wireline operations has initiated for the first well and the wireline is below a surface, based on determining the wireline of the wireline crane is greater than the threshold depth, wherein the current status of the first well is based at least on determining the one or more wireline operations has initiated for the first well and the wireline is below a surface.

23. The computing system of claim 21, wherein to determine the current status of the first well, the at least one processor is further configured to:
determine a wireline of the wireline crane is less than a threshold depth based on the wireline equipment data;
determine a tool of one or more wireline equipment is on, based on determining the wireline of the wireline crane is less than the threshold depth and the wireline equipment data; and
determine one or more wireline operations has initiated, and the wireline is above a surface and the tool is on, based on determining the tool of the one or more wireline equipment is on, wherein the current status is based at least on determining the one or more wireline operations has initiated, the wireline is above the surface and the tool is on.

24. The computing system of claim 21, wherein to determine the current status of the first well, the at least one processor is further configured to:
determine a wireline of the wireline crane is less than a threshold depth based on the wireline equipment data;
determine a tool of one or more wireline equipment is off, based on determining the wireline of the wireline crane is less than the threshold depth and the wireline equipment data;
determine a flow rate of a pump of the one or more wireline equipment is greater than a threshold flow rate, based on determining the tool is off and the wireline equipment data; and
determine one or more wireline operations has initiated, the wireline is above a surface and the pump is active, based on determining the flow rate of the pump is greater than the threshold flow rate, wherein the current status is based at least on determining the one or more wireline operations has initiated, the wireline is above the surface and the pump is active.

25. The computing system of claim 21, wherein to determine the current status of the first well, the at least one processor is further configured to:
determine a wireline of the wireline crane is less than a threshold depth based on the wireline equipment data;
determine a tool of one or more wireline equipment is off, based on determining the wireline of the wireline crane is less than the threshold depth and the wireline equipment data;
determine a flow rate of a pump of the one or more wireline equipment is less than a threshold flow rate, based on determining the tool is off and the wireline equipment data;
determine a drum speed of a winch of the one or more wireline equipment is greater than a threshold drum speed, based on the flow rate of the pump is greater than the threshold flow rate and the wireline equipment data; and
determine one or more wireline operations has initiated, the wireline is above a surface and the winch is active, based on determining the drum speed of the winch is greater than the threshold drum speed, wherein the current status is based at least on determining the one or more wireline operations has initiated, the wireline is above the surface and the winch is active.

26. The computing system of claim 21, wherein to determine the current status of the first well, the at least one processor is further configured to:
determine a wireline of the wireline crane is less than a threshold depth based on the wireline equipment data;
determine a tool of one or more wireline equipment is off, based on determining the wireline of the wireline crane is less than the threshold depth and the wireline equipment data;
determine a flow rate of a pump of the one or more wireline equipment is less than a threshold flow rate, based on determining the tool is off and the wireline equipment data;
determine a drum speed of a winch of the one or more wireline equipment is less than a threshold drum speed, based on the flow rate of the pump is greater than the threshold flow rate and the wireline equipment data;
determine a pressure of a pump of the one or more wireline equipment is greater than a threshold pressure, based on determining the drum speed of the winch is less than the threshold drum speed and the wireline equipment data; and
determine one or more wireline operations has initiated, the wireline is above a surface, the winch is inactive and a pressure of the first well is equalized, based on determining the pressure of the pump is greater than the threshold pressure, wherein the current status is based at least on determining the one or more wireline operations has initiated, the wireline is above the surface, the winch is inactive and a pressure of the first well is equalized.

27. The computing system of claim 21, wherein to determine the current status of the first well, the at least one processor is further configured to:
determine a wireline of the wireline crane is less than a threshold depth based on the wireline equipment data;
determine a tool of one or more wireline equipment is off, based on determining the wireline of the wireline crane is less than the threshold depth and the wireline equipment data;
determine a flow rate of a pump of the one or more wireline equipment is less than a threshold flow rate, based on determining the tool is off and the wireline equipment data;
determine a drum speed of a winch of the one or more wireline equipment is less than a threshold drum speed, based on determining the flow rate of the pump is greater than the threshold flow rate and the wireline equipment data;
determine a pressure of a pump of the one or more wireline equipment is less than a threshold pressure, based on determining the drum speed of the winch is less than the threshold drum speed and the wireline equipment data;
determine the drum speed of the winch of the one or more wireline equipment is greater than the threshold drum speed, based on determining the pressure of the pump is less than the threshold pressure and the wireline equipment data; and
determine one or more wireline operations has initiated, the wireline is above a surface, the winch is active and a pressure of the first well is not equalized, based on determining the drum speed of the winch of the one or more wireline equipment is greater than the threshold drum speed, wherein the current status is based at least on determining the one or more wireline operations has initiated, the wireline is above the surface, the winch is active and a pressure of the first well is not equalized.

28. The computing system of claim 21, wherein to determine the current status of the first well, the at least one processor is further configured to:
determine a wireline of the wireline crane is less than a threshold depth based on the wireline equipment data;
determine a tool of one or more wireline equipment is off, based on determining the wireline of the wireline crane is less than the threshold depth and the wireline equipment data;
determine a flow rate of a pump of the one or more wireline equipment is less than a threshold flow rate, based on determining the tool is off and the wireline equipment data;
determine a drum speed of a winch of the one or more wireline equipment is less than a threshold drum speed, based on determining the flow rate of the pump is greater than the threshold flow rate and the wireline equipment data;
determine a pressure of a pump of the one or more wireline equipment is less than a threshold pressure, based on determining the drum speed of the winch is less than the threshold drum speed and the wireline equipment data;
determine the drum speed of the winch of the one or more wireline equipment is less than the threshold drum speed, based on determining the pressure of the pump is less than the threshold pressure and the wireline equipment data; and
determine one or more wireline operations has initiated, the wireline is above a surface, the winch is in active and a pressure of the first well is not equalized, based on determining the drum speed of the winch of the one or more wireline equipment is less than the threshold drum speed, wherein the current status is based at least on determining the one or more wireline operations has initiated, the wireline is above the surface, the winch is inactive and a pressure of the first well is not equalized.

29. The computing system of claim 21, wherein the at least one processor is configured to execute to further perform operations that include:
obtain the wireline equipment data, the wireline equipment data characterizes one or more attributes of each of one or more wireline equipment; and
obtain the job data of one or more wells including the first well, the job data including, for each of the one or more wells, wireline operations information characterizing a status of each of one or more wireline operations and fracking operations information characterizing a status of each of one or more fracking operations.

30. The computing system of claim 29, wherein the wireline equipment data includes depth information, tension information, drum information, flow rate information and tool information.

31. The computing system of claim 29, wherein the job data further includes location information of each of the one or more wells.

32. The computing system of claim 21, wherein to determine the wireline crane is positioned over the first well, the at least one processor is further configured to:
determine the wireline crane is positioned over the first well for a predetermined time interval based on the wireline crane positioning data.

33. The computing system of claim 21, wherein the at least one processor is configured to execute to further perform operations that include:
obtain the wireline crane positioning data, the wireline crane positioning data including location information of the wireline crane and orientation information of the wireline crane.

34. The computing system of claim 33, wherein the orientation information of the wireline crane is based on sensor data generated by a magnetometer of the wireline crane.

35. The computing system of claim 33, wherein the location information of the wireline crane is based on location data generated by a global positioning system device (GPS) device of the wireline crane.

36. The computing system of claim 21, wherein the at least one processor is configured to execute to further perform operations that include:
obtain the wellhead status data, the wellhead status data being associated with one or more wells including the first well.

37. The computing system of claim 36, wherein the wellhead status data is generated by one or more sensors of the one or more wells.

38. The computing system of claim 37, wherein the one or more sensors includes a hydraulic actuated wellhead sensor.

39. A computer-implemented method comprising:
determining a first well is open based on wellhead status data;
determining a wireline crane is positioned over the first well based on wireline crane positioning data;
determining a current status of the first well based on a portion of job data associated with the first well, and wireline equipment data; and
initiating one or more wellhead operations based on the current status of the first well.

40. A tangible, non-transitory computer readable medium storing instructions that, when executed by at least one processor, cause the at least one processor to perform operations comprising:
determining a first well is open based on wellhead status data;
determining a wireline crane is positioned over the first well based on wireline crane positioning data;
determining a current status of the first well based on a portion of job data associated with the first well, and wireline equipment data; and
initiating one or more wellhead operations based on the current status of the first well.
